(19) United States
(12) Patent Application Publication
(10) Pub. No.: US 2025/0292277 A1
(43) Pub. Date: Sep. 18, 2025

(54) BROWSER EXTENSION FOR AUTOMATICALLY GENERATING FLOATING INTERFACES ON RETAIL PLATFORMS

(71) Applicant: Phia Holdings, Inc., New York, NY (US)

(72) Inventors: Phoebe Gates, New York, NY (US); Sophia Kianni, New York, NY (US)

(21) Appl. No.: 19/072,971

(22) Filed: Mar. 6, 2025

Related U.S. Application Data
(60) Provisional application No. 63/564,986, filed on Mar. 13, 2024.

(51) Int. Cl. G06Q 30/0201; G06Q 10/087; G06Q 30/0601

(52) U.S. Cl. CPC G06Q 30/0206; G06Q 10/087; G06Q 30/0641

(57) ABSTRACT

A system and method for dynamically determining and presenting resale values through a browser extension interface on retail platforms. The browser extension injects a floating interface element into a host web page of a retail product to display real-time resale valuations while users shop online. In particular, the browser extension generates resale estimates and/or projected costs of temporary ownership of an identified product on the host web page. The browser extension progressively displays information where, in response to detecting user interaction with the floating interface element, the browser extension expands to present further valuation metrics and/or secondary sale listings through dynamically generated overlay windows.

### CROSS-REFERENCE TO RELATED APPLICATIONS

This application claims priority to, and the benefit of, U.S. provisional patent application Ser. No. 63/564,986 filed on Mar. 13, 2024, incorporated herein by reference in its entirety.

### BACKGROUND

Online shopping is the process of buying goods or services directly from a seller over the Internet via applications such as a web browser or a mobile application. Existing secondary sales web platforms include a listing interface where users enter specific details of items they wish to list for secondary sales (e.g., auctions). Sellers provide images and item descriptions to the platform. The platform then lists the item. While online shopping offers a plethora of benefits, it is also associated with several challenges. For example, the process can be time-consuming and prone to errors. Additionally, finding good information about a product held for an extended period of time can be difficult and similarly prone to errors.

Email platforms include existing application program interfaces (APIs) that enable filtering of mail and sorting based on numerous attributes.

### BRIEF DESCRIPTION OF THE DRAWINGS

FIG. 1 is a block diagram of a platform for extracting and employing product information from emails.

FIG. 2 is a flowchart illustrating a process for extracting product information from emails.

FIG. 3 is a flowchart illustrating a method that incorporates extracted data into a new object within a digital inventory.

FIG. 4 is a flowchart illustrating image data handling whilst automatically generating a new secondary listing.

FIG. 5 is a screenshot of a digital inventory interface.

FIG. 6 is a screenshot of a secondary listing generator interface.

FIG. 7 is a screenshot of a secondary sale item comparison extension interface.

FIG. 8 is a block diagram of an example environment 800 of a platform for dynamically determining and presenting resale values through a browser extension on a host web page.

FIG. 9 is a flowchart illustrating a process for presenting resale values.

FIG. 10 is a flowchart illustrating a method that incorporates dynamically extracted data into a new object within a digital inventory.

FIG. 11A is a screenshot of a graphical user interface (GUI) integrated with a floating interface element of the browser extension where the resale value is above a particular threshold.

FIG. 11B is a screenshot of the GUI of FIG. 11A integrated with a graphic overlay of the browser extension.

FIG. 11C is a screenshot of the GUI of FIG. 11A integrated with an expanded graphic overlay of the browser extension.

FIG. 11D is a screenshot of an extension web page interface of the browser extension.

FIGS. 12A-12D are screenshots of a GUI integrated with the browser extension where the resale value is below a particular threshold.

FIG. 13 is a screenshot of a user profile screen of the browser extension.

FIGS. 14A and 14B are two screenshots of the same host web page where the browser extension presents different graphic content.

FIGS. 15A and 15B are screenshots of the same host web page where the browser extension presents different graphic content based on whether a product has a predicted resale value over a particular threshold.

FIGS. 16A and 16B are screenshots of the same user interface where the user interface presents different graphic content based on whether a product has a predicted resale value over a particular threshold.

FIG. 17 is a block diagram illustrating an example computer system, in accordance with one or more embodiments.

FIG. 18 is a high-level block diagram illustrating an example AI system, in accordance with one or more embodiments.

### DETAILED DESCRIPTION

Online shopping has become increasingly prevalent, with consumers regularly purchasing retail items through retail platforms. The retail platforms often generate email confirmations including detailed product information, specifications, and purchase records that accumulate in users' email inboxes over time. While these emails serve as digital receipts, the product information contained within them typically remains unutilized after the initial purchase confirmation.

Further, the secondary sales market for retail items continues to grow to facilitate the resale of previously purchased goods. However, listing items for resale often requires sellers to manually input product details, specifications, and images—a time-consuming process that potentially introduces errors when original product information is no longer readily accessible. Additionally, determining appropriate resale pricing remains challenging, as market values fluctuate based on factors like item condition, brand retention rates, and current demand. Existing secondary sales platforms provide basic listing interfaces where sellers manually enter specific details about items the sellers wish to sell. Thus, sellers must locate the original product information, upload new images, and research current market prices to determine the secondary listing values. The manual nature of reselling creates friction in the secondary sales market and potentially deters users from reselling items they no longer need or use.

In addition, when making initial purchase decisions for retail items, consumers face significant challenges in determining potential resale values. Traditional retail platforms display only the current retail price, leaving shoppers unable to evaluate the long-term value retention of potential purchases. The lack of transparency regarding future resale potential creates uncertainty in purchase decisions, particularly for higher-value items where resale value significantly impacts the total cost of ownership. The information gap causes consumers to make purchase decisions without understanding the complete financial implications of their choices.

Further, the distributed nature of sales data across multiple secondary marketplaces creates technical challenges in maintaining data consistency while providing real-time or near real-time valuations. For example, time spent accessing sales data distributed across numerous secondary marketplaces (such as eBay, Overstock, Shopify, Etsy, and others), where each marketplace maintains a separate database of historical transactions and current listings (that, for example, are in different formats), increases due to the complexity of the large volumes of data. Further, traditional e-commerce platforms have no universal or standardized method to aggregate the sales data in real-time or near real-time and are thus unable to generate a real-time or near real-time valuation of the product.

Disclosed herein is an e-commerce platform that enables automation in the generation of secondary sale listings via a digital or virtual personal inventory that is populated through inspection of a user's purchase confirmations in a paired email inbox (e.g., including user consent). Embodiments disclosed herein treat the digital personal inventory as a digital closet (e.g., including all apparel purchased by a given user).

The disclosed e-commerce platform is embodied with a mobile application, a browser extension/plugin, a client application, and/or web platform. Embodiments of the e-commerce platform automatically sync with a user's email account, once paired, to identify and extract purchase history and relevant product information for resale purposes. Email platform APIs enable filtering of mail that narrows the entire inbox solely to order confirmations.

Once a set of order confirmations are identified from the email platform, data regarding product names, purchase date, product ID/SKU, size, color, description, images, purchase URL, and other descriptive data connected to the order confirmation is extracted therefrom. Extraction from identified purchase confirmations is performed via machine learning techniques, HTML parsing and extraction, natural language processing, and/or large language model/generative AI queries.

Once the inventory or digital closet is generated, users are enabled to browse their closet and subsequently automate listing generation for objects within therein. Some values associated with the digital closet and automatic listing generation are pulled from the email extraction, and others are pulled from aggregate data. The data extracted from a given user's email is applied for the benefit of that user specifically. That is, the data is extracted and applied on a one-to-one user basis. Aggregate data such as resale price history for given items at various degrees of condition (brand new, good, fair, damaged, etc.) and average time to sale from listing is provided to the digital closet display.

The digital closet interface enables a number of features across the disclosed e-commerce platform. For example, while shopping, at a primary sale page for a given item, a web browser extension interface displays an overlay window with an estimated resale value (e.g., so a purchaser can readily identify how much they can anticipate obtaining from resale of an item they have yet to purchase and approximate a net cost of temporary ownership). The e-commerce platform uses historical sales data, brand-specific retention rates, real-time market conditions, and other product-related data to generate resale estimates of particular products on a host web page.

For example, when users view products on original retail platforms, the extension first displays a floating interface indicating whether the item represents a value retention above a certain threshold. In some embodiments, user interaction triggers expanded overlays presenting further financial metrics, including projected resale values and/or calculated net costs of temporary ownership. Embodiments include using different visual treatments based on whether items exceed or fall below predetermined value retention thresholds. Embodiments of the overlay window include aggregate resale data and/or live representations of existing secondary sale listings.

In response to a user purchasing a particular product, embodiments include adding the product of the host web page within the digital closet. The digital closet further enables users to quickly generate automatic secondary sale lists for the items in their digital closet employing the data extracted from their email inbox, as well as the aggregate data. Generated listings are automatically placed on one or more resale e-commerce platforms (e.g., eBay, Overstock, Shopify, Etsy, AliExpress, Bonanza, Craigslist, eBid, Lazada, TCGplayer, or other suitable alternatives and equivalents).

As used herein, “retail items,” “consumer goods,” or “consumer items” refers generally to items that a user purchases online via e-commerce platforms. Examples include clothing and accessories such as, but not limited to, dresses, suits, jeans, shirts, skirts, hats, belts, and scarves and footwear such as shoes, boots, and sandals.

In addition, “vendor,” as used herein, refers generally to merchants, users, or other parties that offer consumer goods for sale online. Moreover, “seller” may further refer to merchants, vendors, other users, or other entities that have a relationship that have their consumer goods searched for sale and are searchable from recommendation applications.

Many examples are provided herein as related to apparel (e.g., implemented in a digital closet); however, the e-commerce platform is adaptable to serve other suitable consumer items resold on a secondary market. For example, collectible cards, such as those associated with trading card games, are purchased from numerous sources all over the Internet and are similarly listable on resale platforms such as TCGplayer.

Other illustrative examples include electronics, which may include but are not limited to items such as smartphones, laptops, TVs, cameras, headphones, and various accessories for these devices. Further examples include kitchenware, bedding, toys and games, video games, action figures, dolls, educational toys, collectibles, sports gear, camping equipment, bicycles, fitness equipment, watches and jewelry, car parts, automotive accessories, or tools.

### Extracting Product Information Using the E-Commerce Platform

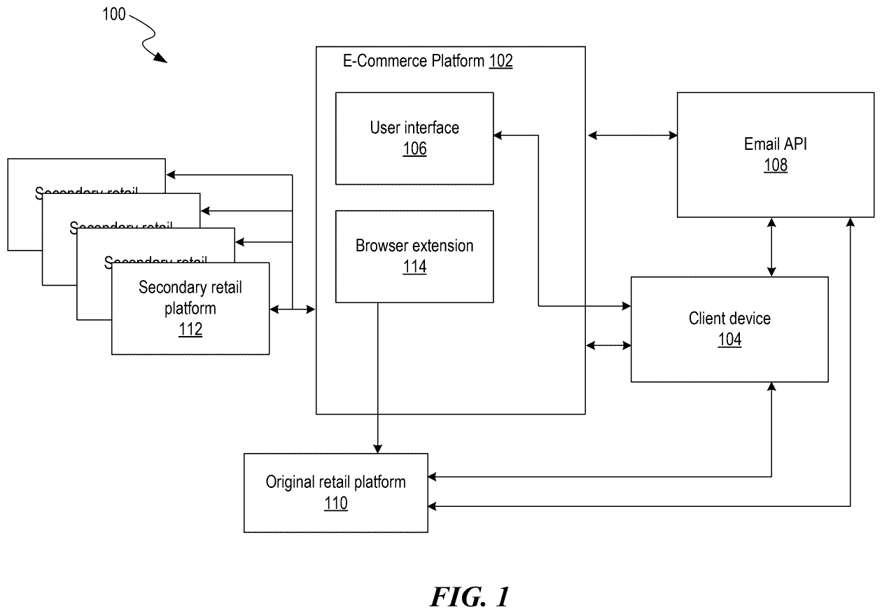

FIG. 1 is a block diagram of a system 100 for extracting and employing product information from emails. An e-commerce platform 102 is an application that executes on a host server (not pictured). The host server communicates via the e-commerce platform 102 with a client device 104. The client device 104 communicates with the e-commerce platform 102, and the user of the client device 104 engages with the e-commerce platform 102 via a user interface 106.

The client device further communicates with an email server API 108 in order to consume an associated email application. The client device 104, in the course of operating online, engages with an original retail platform 110 (e.g., any web shopping platform, such as Amazon, Walmart, Macy's, Christian Dior, Chanel, etc.) and makes purchases. In turn, the original retail platform 110 transmits receipt emails associated with purchases to the email to the user of the client device 104 via the email server API 108.

Upon being granted permission, the e-commerce platform 102 communicates with an email server API 108 and extracts information from the receipt emails that the original retail platform 110 sent to the user's email account. Examples of filters applied using the email server API include filtering by sender (e.g., Amazon, Walmart, Macy's, and so forth), filtering by topic (e.g., emails with subjects like “Order Confirmation,” “Your Purchase Receipt,” “Thank You for Your Order,” and so forth), and/or filtering by body keywords (e.g., terms within the email content such as “order number,” “total amount,” “shipping address,” “item description,” and so forth). Extracting this data enables the e-commerce platform 102 to generate a digital inventory (e.g., a digital closet) of the user's shopping across multiple original retail platforms 110. Using the user interface 106 of the digital inventory, the client device 104 is enabled to trigger the automatic generation of a secondary sale listing on each of a plurality of secondary retail platforms 112. The e-commerce platform 102 is enabled to present the browser extension 114 on websites visited (e.g., the host web page 802) while the user is shopping on an original retail platform 110 via the client device 104.

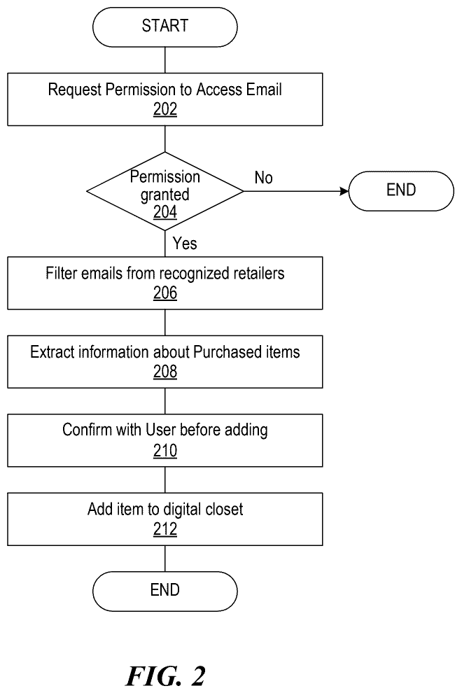

FIG. 2 is a flowchart illustrating a process for extracting product information from emails. In step 202, the e-commerce platform requests permission to access a given user's email account. The request pairs through applications and connects associated endpoint APIs (e.g., of the e-commerce platform and the email server) with one another. In step 204, the user determines whether to grant access to the associated endpoint APIs. Where the user does grant access, the method proceeds.

In step 206, the e-commerce platform seeks and identifies relevant emails that contain product confirmations or purchase receipts. The filtering is performed using keyword searches on a full inbox and associated folders. Subsequent iterations of step 206 include time limitations in addition to keyword searches so as to only capture new, previously uncaptured emails. Limiting by a time frame improves processing efficiency for the creation and subsequent updating of the user's digital inventory. By restricting the search to emails received within a specific time period, the e-commerce platform reduces the volume of data processed and avoids redundant processing of older emails that have already been indexed. The identification of relevant emails is performed each time the user makes use of the e-commerce platform.

In step 208, product data is extracted from the filtered/identified emails. Emails for product confirmations tend to have wildly different formatting, structure, and information delivery. There is no reason to expect the email confirmation that comes from old, established retail companies to be similar to small, bespoke businesses or similar to general retailers that serve wildly variable products. Extracting the desired information in a computationally efficient manner is a challenge due to this variability. Variability in data presentation leads computer systems to be prone to error.

The techniques employed to identify the relevant product data vary by embodiment. In some embodiments, machine learning or artificial intelligence (AI) is employed to identify and extract relevant product information. In some implementations of machine learning or AI, natural language processing is employed to identify keywords or key contexts that match patterns associated with product data.

In some embodiments, external, pretrained AI models are employed, such as generative AI, or large language models. Such generative models tend to be applicable to general-purpose questioning without pretraining or significant training configuration. Other models are pretrained for the particular purpose of extracting the relevant product data from the emails. Where a pretrained model is employed, prompt or command set engineering is employed to narrowly tailor the result of the AI model.

Command set engineering defines the input matter (e.g., product sale confirmation emails) and constructs a set of expected fields the AI is to fill. For apparel, an illustrative example set of fields and definitions thereof include:
ID: number corresponding to each product that starts from 1 and increases by 1 with each product ordered.
Description: assigned name of the product on the receipt.
Category: appropriate category of the product.
Brand: brand of the product.
Size: size of the product.
Price: price of the product.
Additional Tags: additional features of the products that are detailed in the receipt, such as style, material, color, or more.
Image: a URL or resource location that corresponds to an image of the product.

The above fields serve as non-limiting exemplary fields. A given embodiment employs more or fewer of such fields and with varying descriptions as best configured with an employed AI model. In some embodiments, relevant information is contained in images present in the email or attachments (e.g., PDF files). In such circumstances, optical character reading (OCR) programs are employed to extract the necessary data.

In some embodiments, multiple command sets are applied first to identify what sort of product is being described in the email. For example, a purchase of non-apparel collectibles would not necessarily include all the fields above (like “size”). Thus, a first AI command set is employed to identify a type of product, and a predetermined subsequent command set, determined based on the model output in response to the first command set, is employed and constructs fields to fill based on the relevant product. The command set further identifies a structure of the output, such as a JSON or HTML format that is consumable by the e-commerce application.

The command set effectively programs the AI model by indicating which objects should be created by the query. Configuring the model output, via command set engineering, in a consumable format enables an application to recognize expected fields from an otherwise unstructured or inconsistent format of an email confirmation.

In some embodiments, the platform makes use of cascading content analysis in the emails. For example, the platform first makes use of HTML, then email API content (e.g., Gmail formatting and data extraction), and then reviews attachments (e.g., PDF receipts, images, or other documents) if present. The e-commerce platform proceeds down a cascading list until all information fields are filled. Where the information fields are filled in earlier stages of analysis, the e-commerce platform need not proceed to subsequent stages, thus preserving computing resources.

In step 210, once the information is extracted, the user is presented with a sample or expected view of the new item(s) to add to their digital inventory. The user is enabled to confirm the information is correct via a single click or attempt to correct the entry. In step 212, confirmed items are added to the user's digital inventory.

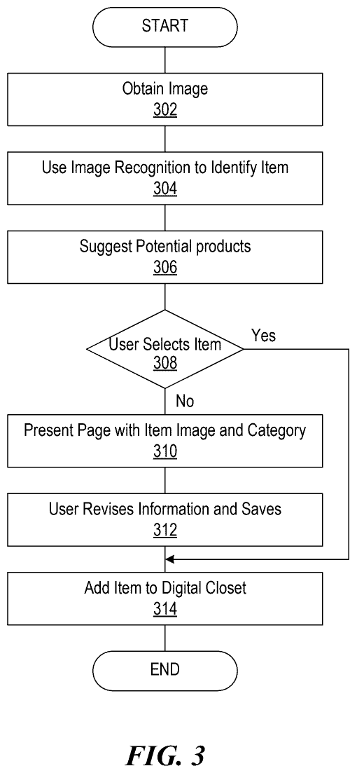

FIG. 3 is a flowchart illustrating a method that incorporates extracted data into a new object within a digital inventory. The depicted method is employed to add new items to a digital closet by photograph or to supplement existing items as generated via email extraction. In step 302, a product image is obtained (e.g., captured, uploaded, and so forth). The capture is either prompted by a user request to add a new item to their digital inventory or by the platform seeking to backfill information that was either not available (at inception or presently) or had become corrupted. Examples of product images include both images of the physical product or images of the receipt (e.g., paper receipt) for the product. For example, the user request is in the form of a user clicking or otherwise interacting with a particular button or portion of a web page. Once the user request is received (e.g., a user clicks on an “add to closet” button), the capture of the product image is triggered.

In some embodiments, in response to receiving a notification that a user has purchased a particular product, a pop-up is triggered to be presented on the web page/user interface and includes an interactive area enabling the user to trigger capture, via the computing device, of the product image. For example, the pop-up includes an interactive area that prompts the user with the option to add the newly purchased item to their digital closet. The interactive area includes text or other visual indicators, such as “Would you like to add this item to your closet?” along with buttons for “Yes” and “No.” If the computing device receives a user indication on the user interface to add the item to their digital closet, the platform proceeds to capture the product image of the product that was purchased. The automated pop-up enables users to quickly and easily update their digital inventory with new purchases.

It is contemplated that many users would create email inbox rules to routinely delete emails, or if they are running up against space limits of their inbox, that the inbox itself would begin deleting information. In such circumstances, a user would seek to add items to their digital inventory in another way, such as via image search.

In step 304, image recognition is employed to identify the item. If the image is a “professional image,” reverse image search may identify the location of the image on the web and then link the e-commerce platform to the original retail purchase location. Where the image is an ad-hoc capture, image recognition is still performed to compare content of the image with images within a corpus of training data. The search makes use of computer vision, AI, and/or known search engine techniques to identify a set of results or matches to the image. Where the image is of a receipt, optical character reading is employed to identify the text thereon and then subsequently apply Internet search to the text to identify a given product that matches the receipt.

In step 306, after the image recognition is performed, high-confidence results (e.g., results having above a threshold model confidence) are presented to the user as suggestions. In step 308, the user selects one of the available suggestions or not. Where the user confirms one of the suggestions, the method skips to step 314. In step 310, where a user does not confirm any of the suggestions, the e-commerce platform provides a new item/product page with as many filled-in fields as the computer vision/Internet search of step 304 was able to determine confidently. In step 312, the user revises the information as necessary. In step 314, the product is added to the user's digital inventory. Where the product was already present in the inventory, the existing entry is revised as indicated.

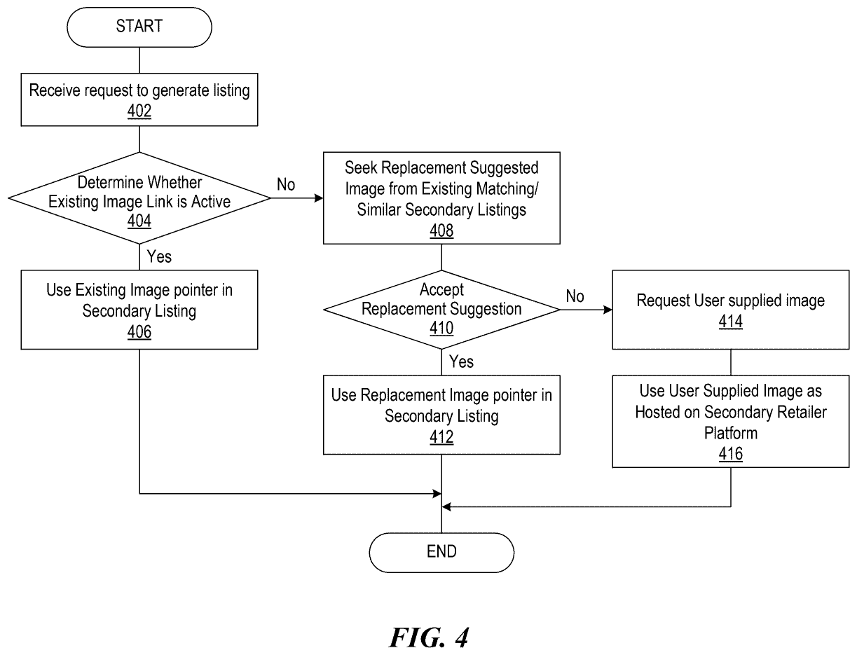

FIG. 4 is a flowchart illustrating image data handling whilst automatically generating a new secondary listing. In step 402, a user requests via their digital inventory to generate a secondary sale listing. In some embodiments, this method triggers as a digital inventory maintenance procedure (e.g., to keep the inventory looking vibrant and improve the user experience by not using dead images). Thus, in some embodiments, the first step (step 402) is instead triggered by a user loading into their digital inventory or otherwise logging in to the e-commerce platform.

In step 404, the platform determines whether an image of an associated digital inventory entry is active. The images employed are typically pointers so as to not require hosting of images. Hosting images across a large user base requires significant storage and is relatively inefficient host server execution. While the host server may host images if necessary, doing so is not necessarily ideal. In the case of product images extracted from emails, which may be many years old and directed to products that are no longer available in a primary or first sale, image pointers will go down, corrupt, or cease being hosted. The original retailer, especially in the case of products like apparel, which are seasonal, is not necessarily motivated to continue to host a professional image of the product forever. Thus, the e-commerce platform has developed a method for addressing the circumstances where image hosting goes down.

Whether an image is present at a given point is an easy validation check based on an API request and response to the original image. Where the image continues to be present, in step 406, the platform continues to use the existing image pointer. In step 408, where the image is not available, the e-commerce platform seeks a new image. To identify a new image, the platform automatically performs Internet searches using the textual data relating to the product (e.g., color, product name, brand, model number, or other product attributes) in order to attempt to find a new image for that product. Based on the results of that search, the user is presented with suggested images. In some embodiments, instead of presenting the user with the suggestions, an AI model, such as a general-purpose model as described above, is employed to identify the suitableness of the found image. For example, the AI model compares the visual features of the found images with known characteristics of the product to determine a degree of suitableness (e.g., similarity) between the found image and the product. In some embodiments, the AI model further identifies the suitableness of the found image using metadata associated with the images, such as file names, alt text, and/or surrounding text on the web pages where the images were found.

In step 410, the arbiter of the found image is queried as to whether the suggested image(s) is acceptable. In step 412, where the image is accepted (e.g., by the user or by an AI model), the digital inventory entry is updated to use the new image pointer. In step 414, where the suggestions are not accepted, the user is queried to provide a new image (e.g., via upload or client device capture). In step 416, the new image is tied to the digital inventory. Throughout the process, a placeholder image is employed until an image is determined.

Hosting of the new image (e.g., as captured in step 414) varies based on the embodiment. In some embodiments, the e-commerce platform hosts the new image. In some embodiments, the new image is temporarily hosted until one or more secondary sale listings are generated and the secondary sale platforms will host the image as associated with the listing. When the secondary sale listing is created, the e-commerce platform ceases to host the image and stores a pointer (e.g., URL) to the secondary sale listing instead. In some embodiments, the image is not hosted by the e-commerce platform and the image only appears in the digital inventory once a pointer exists to a secondary listing hosted image.

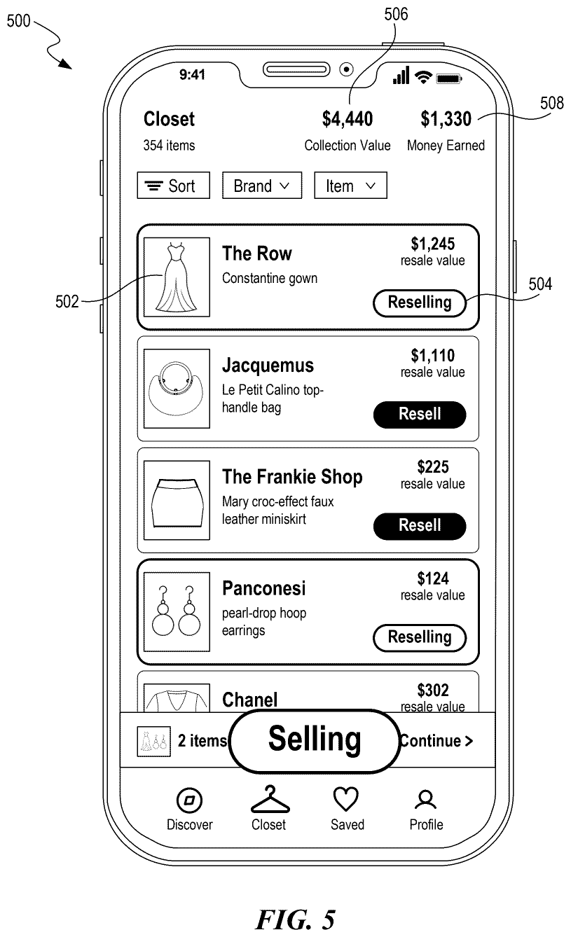

FIG. 5 is a screenshot of a digital inventory interface 500. The digital inventory interface 500 includes entries 502 for each item within the inventory. These items each include a resell button 504 to create a secondary sale listing. In some embodiments, pressing the resell button for a given item causes the e-commerce platform to automatically generate a secondary sale listing on one or more secondary retail services (e.g., Internet auctions or “Buy Now” pages). The automated generation of secondary listings makes use of default settings that either the user predetermines or applies system defaults. The data extracted from the email receipts that generated the digital inventory is employed in the generation of the secondary listing.

Some data, such as the price employed by the secondary listing, is derived from aggregate data of secondary sale values that correspond to the condition or the described item. In some embodiments, prior to the generation of the secondary sale listing, the user is prompted to provide the condition of the item and additional, contemporary images of the item (e.g., to illustrate condition).

Embodiments of the digital inventory interface 500 further include an estimated value 506 of the inventory based on aggregate data relating to item price as identified from live or recent secondary sales of matching items. In some embodiments, the digital inventory further provides a combined value of items that were sold via the e-commerce platform 508 from the digital inventory of the subject user.

In some embodiments, the owner of a digital inventory can share their inventory to other APIs to consume, such as social media or affiliate platforms. The inventory is thus exportable data via API requests. Users viewing the digital inventory via social links (e.g., an influencer or celebrity shares their closet so that others may purchase items similar to those they have obtained) are further enabled to “buy now” on matching (but distinct) items. That is, a buy now link on an item that is not presently subject to a secondary sale listing from the digital inventory owner delivers a user to a primary purchase location (e.g., original retailer to buy new) or to a secondary sale listing for a matching item. Where the digital inventory owner has listed the item, the buy now link directs to a secondary sale listing of the specific item from the digital inventory.

Further, the digital inventory includes an affiliate link conversion. That is, when users add items to their inventory (e.g., through the means described above), the platform identifies whether the item is associated with an available merchant for affiliate linking. Affiliate linking enables users (especially influencers) to earn commissions on items purchased through their recommendations. If a given inventory owner seeks to make their purchase public, the platform autogenerates affiliate commissions if they already have a relationship with the website where the receipt is from or suggests an affiliate commission for a website that is selling the same product.

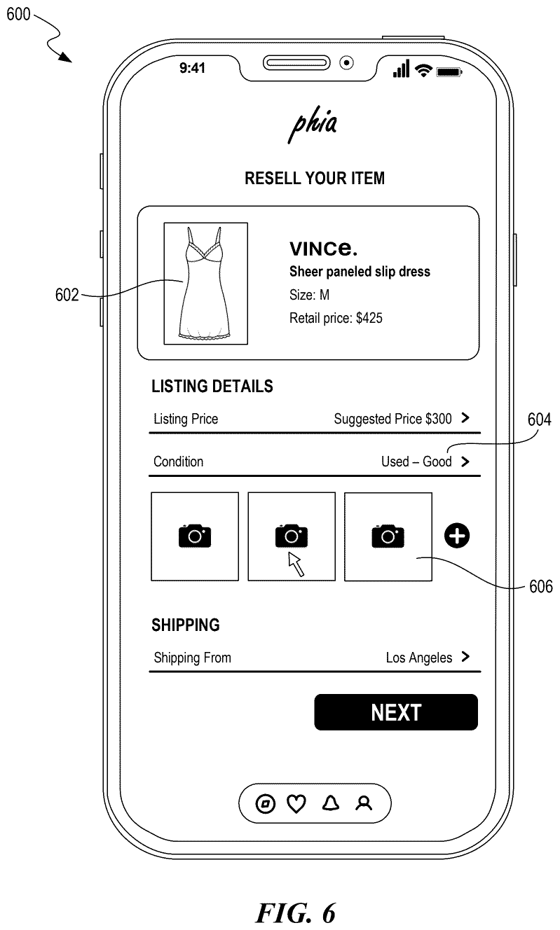

FIG. 6 is a screenshot of a secondary listing generator interface 600. As a user seeks to generate a secondary listing, they are presented with a brief item description/image 602 and fields to fill in 604 (e.g., item condition and price). The user is further queried to provide contemporaneous images 606 of the item to evidence possession and condition.

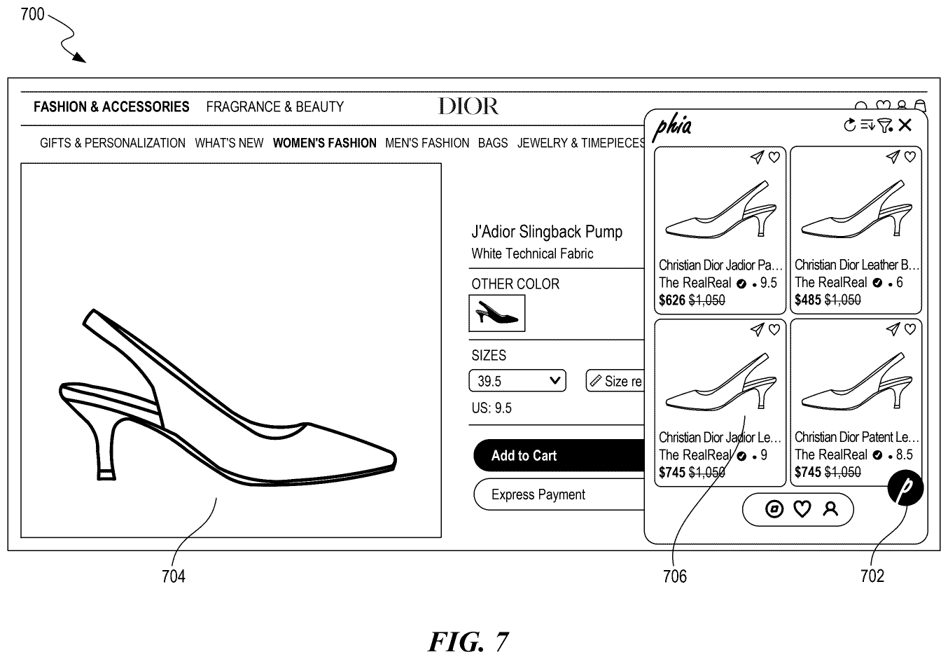

FIG. 7 is a screenshot of a secondary sale item comparison extension interface 700. The extension interface 700 is accessed by a floating button 702 that appears while a user is browsing an original retail platform page 704. When activated, the extension presents a list interface 706 that presents information about resale potential for the item displayed on the original retail platform page 704. A floating button is a web interface button that does not shift around in response to the user shifting the core page (e.g., as with a scroll bar). In some embodiments, a floating button is adjustable independent of the core webpage. A floating button gives the appearance of “floating” over the core webpage.

The information presented in the list interface varies by embodiment. In some embodiments, the list interface 706 presents examples of live secondary sale listings for the product on the original retail platform page 704. The example listings enable the user to either buy secondhand (and potentially save) and/or provide data points to determine how much they can expect to receive should they wish to purchase new and subsequently resell after a period of use. In some embodiments, the list interface 706 includes an average price across recent secondary sales (as opposed to live pending secondary listings) and/or information related to how long those secondary sales were pending before they closed.

### Presenting Predictive Overlay Windows Using the E-Commerce Platform

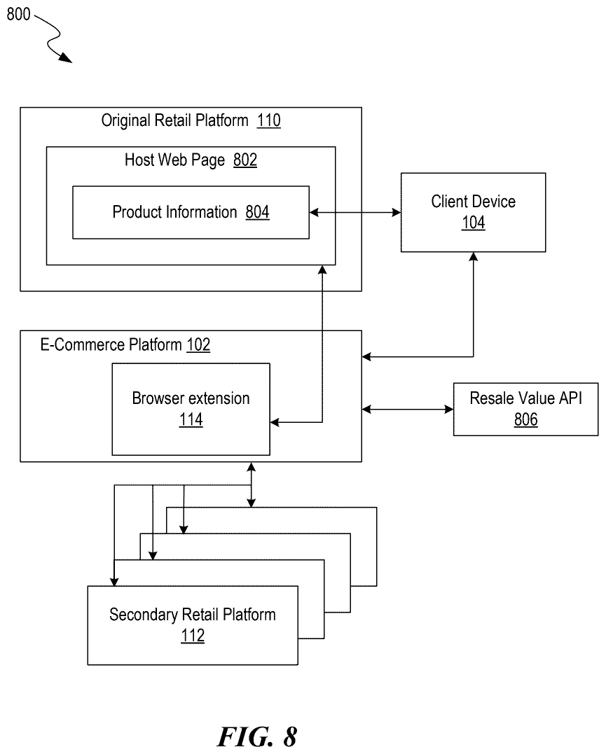

FIG. 8 is a block diagram of an example environment 800 of the e-commerce platform 102 dynamically determining and presenting resale values through a browser extension on a host web page. Environment 800 includes the e-commerce platform 102, the client device 104, the original retail platform 110, the secondary retail platform(s) 112, the browser extension 114, the host web page 802, the product information 804, and the resale value API 806. Embodiments of the environment 800 can include different and/or additional components or can be connected in different ways.

The e-commerce platform 102 connects to the host web page 802 of the original retail platform 110 to retrieve product information 804 of product(s) on the host web page 802. The e-commerce platform 102 uses the resale value API 806 to obtain current market data on resale values, and generates a predicted/estimated resale value of the product(s) on the host web page. In some embodiments, the e-commerce platform communicates with secondary retail platform(s) 112 to compare and display potential resale channels on the client device 104. The client device 104 refers to the user's terminal, such as a personal computer, tablet, or smartphone, which accesses the original retail platform 110 via a web browser. In some embodiments, the e-commerce platform 102 presents the product information 804 retrieved by the host web page 802 (e.g., when a user pastes a product link to the host web page 802).

Using the browser extension 114, the client device 104 presents dynamically generated resale values directly on the host web page 802. The browser extension 114 retrieves product information from the original retail platform 110 and sends requests to the e-commerce platform 102 to obtain corresponding resale values. The host web page 802 is the interface presented to users via the client device 104, where product information 804 is displayed. The host web page 802 integrates with the browser extension 114 associated with the e-commerce platform 102, enabling the dynamic display of real-time resale values alongside the original product information.

The original retail platform 110 is an e-commerce website or online marketplace that presents products for sale. The original retail platform 110 hosts the host web page 802, which displays product information 804 used by the e-commerce platform 102 to perform resale value calculations. Product information 804 includes corresponding information of the products listed on the host web page 802. Product information 804 includes, but is not limited to, product titles, descriptions, images, specifications, prices, and/or availability status.

Secondary retail platform(s) 112 are various online marketplaces or resale websites where the products can be resold. The e-commerce platform 102 connects to the secondary retail platform(s) 112 to gather product data on respective resale markets. For example, product data includes listing prices, sales volumes, market demand, and so forth for the products. Using the product data, the e-commerce platform 102 presents a dynamically generated resale value to enable users to make informed decisions on where to resell their items. The resale value API 806 supplies the e-commerce platform 102 with up-to-date information on product resale values. The resale value API 806 aggregates market data such as the product data sourced from the secondary retail platform(s) 112, historical sales data, market trends, and so forth. The e-commerce platform 102 dynamically calculates and presents accurate resale values to users browsing the host web page 802.

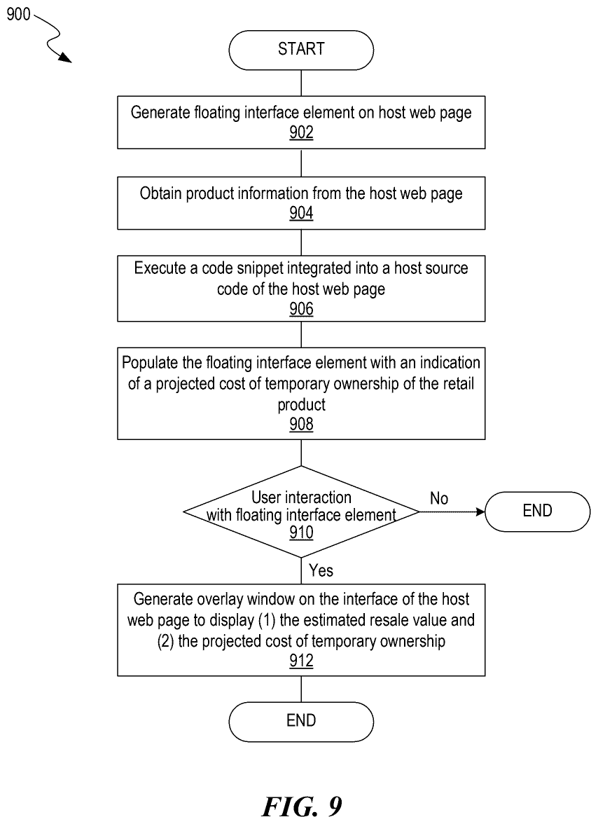

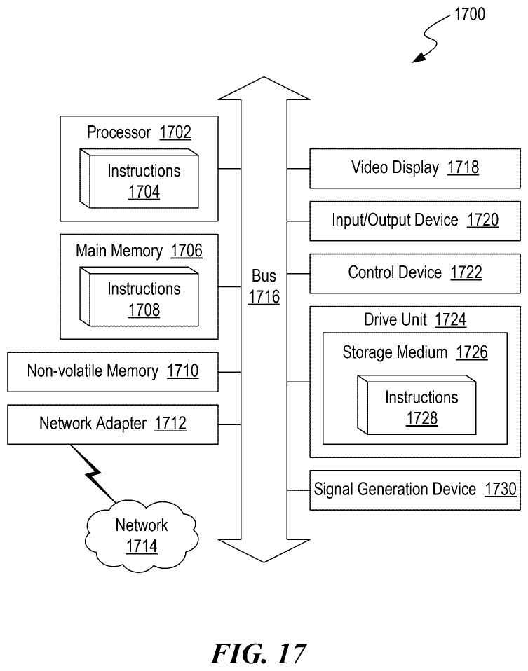

FIG. 9 is a flowchart illustrating a process 900 for presenting resale values. In some embodiments, the process 900 is performed by components of example computer systems 1700 illustrated and described in more detail with reference to FIG. 17. Embodiments of the process 900 can include different and/or additional operations or can perform the operations in different orders.

In operation 902, the e-commerce platform 102 generates, on the interface of a host web page (e.g., host web page 802 in FIG. 8), a floating interface element. The host web page displays a retail product on the interface. In some embodiments, the host web page is associated with an electronic commerce store (e.g., original retail platform 110 in FIG. 1). The floating interface application is located proximate to a buy button region of the interface of the host web page, and the electronic commerce store includes a checkout screen that allows a purchase of the retail product in response to receiving user input within the buy button region.

In operation 904, the e-commerce platform 102 obtains product information (e.g., product information 804 in FIG. 8) from the host web page. The product information includes a product title, a product price, and/or a product description. For example, the e-commerce platform 102 initiates a connection to the host web page through a web browser on a client device (e.g., the client device 104 in FIG. 1 and FIG. 8).

For instance, the e-commerce platform 102 sends an HTTP request to fetch a product page's HTML and scrapes through the HTML to find specific tags (e.g., title, price, product details) including the product information. The e-commerce platform 102 structures the product information into a structured format. For example, the e-commerce platform 102 scrapes a host web page displaying a trading card “Blue-Eyes White Dragon” to identify product information such as the card's name, the current market price, a description including the card's condition and rarity, and so forth. Similarly, the e-commerce platform 102 scrapes a host web page displaying a fashion item, such as a women's dress from a clothing retailer, to identify product information such as the dress's name, the current selling price, and a description including details about the dress's size, material, style, and so forth.

In operation 906, the e-commerce platform 102 executes a code snippet integrated into a host source code of the host web page. The code snippet executes an external call to an API (e.g., resale value API 806 in FIG. 8) via the Internet that determines an estimated resale value for the retail product based on (1) the product information and/or (2) historical resale data from multiple secondary marketplaces. The secondary marketplaces are online platforms where users resell their products, such as eBay, Amazon Marketplace, TCGplayer, and other resale sites.

To determine the estimated resale value for the retail product, the API calculates an average or median resale value of the retail product based on the historical resale data associated with the retail product. The historical resale data includes past sale prices, dates, and/or product conditions and is collected through HTTP requests to the retail platforms' APIs or web scraping the retail platforms' listings if APIs are not available. The API uses historical resale data to calculate the average or median resale value of the retail product by querying the database to retrieve all past sale prices of the specific product and computing the mean of these prices using statistical functions. For example, if the historical sale prices of a product are $50, $55, $60, and $65, the average resale value is calculated as $57.5.

The API further calculates an average or median resale retention percentage based on the historical resale data associated with multiple different retail products by determining the ratio of the resale price to the original retail price for each product and then averaging the ratios. For instance, if the resale retention percentages for various products are 70%, 75%, 80%, and 85%, the average resale retention percentage is 77.5%. The API applies this average or median resale retention percentage to the original retail price of the retail product to determine its estimated resale value. For example, if the original retail price of the product is $100 and the average resale retention percentage is 77.5%, the estimated resale value is calculated as $77.5.

In some embodiments, the API and/or the e-commerce platform 102 adjusts the estimated resale value based on an item condition of the retail product, market demand of the retail product, and/or a degree of popularity within one or more consumer groups of the retail product. A condition factor indicates a condition of the retail product (e.g., new, like new, used). For instance, a product in “like new” condition retains 90% of its estimated resale value, while a “used” product retains only 70%. The current market demand for the product is evaluated using real-time or near real-time data from secondary retail platforms, where high demand increases the estimated resale value, while low demand decreases the estimated resale value. The degree of popularity within consumer groups is determined through, for example, social media trends, reviews, sales data, and so forth, where popular products receive a positive adjustment, while less popular ones receive a negative adjustment.

The API calculates the final estimated resale value by applying the adjustments to the initial estimated resale value. For example, if the initial estimated resale value is $77.5 and the condition factor is 0.9 (for “like new” condition), the final resale value is $69.75. Thus, the e-commerce platform 102 provides a dynamic and accurate estimation of the resale value for retail products by considering historical data, market conditions, and/or product-specific factors.

In some embodiments, the API determines the estimated resale value for the retail product based on (1) historical resale data of the retail product and (2) historical resale data of predicted products associated with the retail product. For example, the predicted products are determined using an AI model. The AI model is trained using a dataset of product information and/or historical resale data. The AI model is fed with features such as product categories, brands, specifications, and/or resale prices and trained to recognize patterns and relationships between different products and corresponding resale values.

For example, if the retail product is a specific model of a smartphone, the AI model predicts other models from the same brand or similar models from competing brands that share similar characteristics and are likely to have comparable resale values. The API collects historical resale data (e.g., past sale prices, dates, product conditions) for these predicted products from the same secondary retail platforms to calculate average or median resale values and resale retention percentages for the predicted products, similar to the process used for the retail product itself. To determine the estimated resale value for the retail product, the API combines the historical resale data of the retail product with the historical resale data of the predicted products by calculating a weighted average of the resale values, where the weights are determined based on the similarity scores assigned by the AI model. For instance, if the AI model predicts that a particular product is highly similar to the retail product, the product's resale data will have a higher weight in the calculation.

In response to executing the code snippet, in operation 908, the e-commerce platform 102 populates the floating interface element with an indication (e.g., color, word, phrase, monetary amount and so forth) of a projected cost of temporary ownership of the retail product determined as a difference between an original retail price and the estimated resale value of the retail product. For example, if the original retail price is $100 and the estimated resale value is $60, the projected cost of temporary ownership is $40.

In some embodiments, the e-commerce platform uses one or more machine learning or artificial intelligence (AI) models to determine the estimated resale value for the retail product based on historical data. The historical data can include information associated with resale values such as, historical sale prices of the product, historical sales volumes of the product, the average duration items remain listed before being sold, and so forth. The AI model can identify patterns and trends within the historical data to enable it to predict future resale values based on historical trends.

In operation 910, the e-commerce platform 102 determines whether the floating interface element has been selected by a user of the host web page via, for example, an event listener configured to detect specific user actions, such as clicks or touch gestures. If not, the process 900 ends. In response to receiving an indication that the floating interface element has been selected by a user of the host web page, in operation 912, the e-commerce platform 102 generates an overlay window on the interface of the host web page. The overlay window displays information including (1) the estimated resale value and/or (2) the projected cost of temporary ownership. The information displayed in the overlay window is not included in the host source code. The indication that the floating interface element has been selected by the user of the host web page includes, for example, a user gesture on a touchscreen element of the interface in a position proximate to the floating interface element or a received input that a user cursor associated with a user device is hovering over the floating interface element.

In some embodiments, the overlay window further includes one or more buttons. The e-commerce platform redirects the user to a second web page in response to received input that the one or more buttons are clicked. The second web page is associated with a set of secondary market listings of the retail product from a set of secondary online retailers.

Upon receiving an indication of a purchase of the retail product by the user, the e-commerce platform 102, in some embodiments, automatically adds the retail product to a digital inventory associated with the user. The e-commerce platform 102 tracks the estimated resale value of the retail product over time. The estimated resale value is indicated within the digital inventory to enable the user to view changes in the estimated resale value. For example, when a user completes a purchase, the e-commerce platform 102 receives a notification or callback from the host web page, including details of the purchased product, such as the product ID, purchase price, and/or user ID. Upon receiving this notification, the e-commerce platform 102 adds the retail product to the user's digital inventory.

The digital inventory is a database or data structure that stores information about products owned or manually added by the user, with each entry including details such as the product ID, purchase price, purchase date, and/or the current estimated resale value. The e-commerce platform 102 updates the digital inventory by inserting a new record for the purchased product. The e-commerce platform 102 tracks the estimated resale value of the retail product over time by automatically or manually recalculating the resale value based on changes in market data, historical sales data, and so forth. To enable the user to view changes in the estimated resale value, the e-commerce platform provides a user interface that displays a list of all the products in the user's digital inventory, along with their current estimated resale values and/or any changes over time.

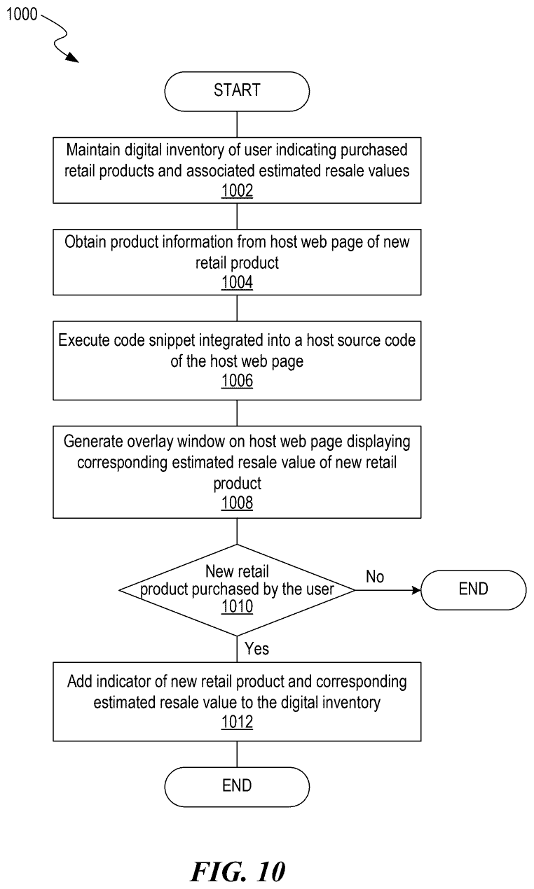

FIG. 10 is a flowchart illustrating a method 1000 that incorporates dynamically extracted data into a new object within a digital inventory. In some embodiments, the method 1000 is performed by components of example computer systems 1700 illustrated and described in more detail with reference to FIG. 17. Embodiments of the method 1000 can include different and/or additional operations or can perform the operations in different orders.

In operation 1002, the e-commerce platform 102 maintains a digital inventory (e.g., the digital inventory discussed with reference to FIGS. 1-9) of a user indicating purchased retail products and associated estimated resale values of the purchased retail products. The estimated resale values are determined based on, for example, historical resale data from multiple secondary marketplaces. In operation 1004, the e-commerce platform 102 obtains product information (e.g., product information 804 in FIG. 8) from a host web page (e.g., host web page 802 in FIG. 8) displaying a new retail product on an interface. The new retail product is different from the purchased retail products. The product information is obtained using, for example, methods discussed with reference to FIG. 9.

In operation 1006, the e-commerce platform 102 executes a code snippet integrated into a host source code of the host web page. The code snippet executes an external call to an API (e.g., resale value API 806 in FIG. 8) via the Internet that determines a corresponding estimated resale value for the new retail product based on (1) the product information and/or (2) the historical resale data from the multiple secondary marketplaces. The estimated resale value is determined using, for example, methods discussed with reference to FIG. 9. In some embodiments, the API determines a brand-specific average or median resale retention percentage based on the historical resale data of multiple items sharing a common brand of the retail product.

The e-commerce platform 102 and/or API, in some embodiments, establishes a set of API connections with the multiple secondary marketplaces and determines the corresponding estimated resale value of the new retail product in association with each secondary marketplace of the multiple secondary marketplaces in parallel. For example, the API sends parallel requests to each secondary marketplace to determine the estimated resale value of the new retail product to reduce the overall time required to gather the data. Each API request sends the product information to the respective marketplace's endpoint and retrieves the estimated resale value.

The e-commerce platform 102, in some embodiments, filters product listings from the multiple secondary marketplaces based on a set of keywords and a set of time periods. The keywords are chosen to match the particular attributes of the retail product, such as brand names, model numbers, and specific product features. The time periods define the range within which the listings are considered valid, such as listings posted within the last month or year. The e-commerce platform 102 prioritizes the filtered product listings based on a confidence score associated with the filtering. The confidence score reflects the likelihood that the listing accurately matches the retail product based on the filtering criteria and is calculated using a combination of factors, including the number of matching keywords, the relevance of the keywords, the recency of the listing, and so forth. For instance, a listing with multiple high-relevance keywords and a recent timestamp receives a higher confidence score than a listing with fewer or less relevant keywords and an older timestamp. Listings with higher confidence scores are given higher priority and are presented to the user first to help users quickly identify the most relevant and/or reliable resale opportunities.

In response to executing the code snippet, in operation 1008, the e-commerce platform 102 generates, on the interface of the host web page, an overlay window displaying the corresponding estimated resale value of the new retail product using methods discussed with reference to FIG. 9. In operation 1010, the e-commerce platform 102 determines whether the new retail product has been purchased by the user using methods discussed with reference to FIG. 9. If not, the method 1000 ends. In response to receiving an indication that the new retail product has been purchased by the user, in operation 1012, the e-commerce platform 102 adds an indicator of the new retail product and the corresponding estimated resale value to the digital inventory. In response to obtaining new market data, the e-commerce platform 102 updates the associated estimated resale values of the purchased retail products using methods discussed with reference to FIG. 9. The e-commerce platform 102 generates one or more notifications responsive to a change in one or more estimated resale values exceeding a predefined threshold.

In some embodiments, the API determines a total portfolio value of the digital inventory including the corresponding estimated resale value of the new retail product and the associated estimated resale values of the purchased retail products. The API and/or e-commerce platform 102 determines an impact value on the total portfolio value if the new retail product is added to the digital inventory. The e-commerce platform 102 presents (1) the total portfolio value and (2) the impact value on the overlay window. In some embodiments, the API determines a total portfolio value of the digital inventory including the estimated resale value of the new retail product. The e-commerce platform 102 displays the total portfolio value and aggregate earnings from previous sales within the overlay window.

To take advantage of particular resell periods, the e-commerce platform 102 determines a selling time period of the new retail product based on one or more patterns associated with historical resale values of the new retail product and automatically generates a secondary resale listing for the new retail product at the selling time period. The selling time period refers to the specific timeframe identified by the e-commerce platform 102 during which a product is most likely to achieve the highest resale value. To identify the selling time period, the e-commerce platform 102 identifies patterns and trends in the resale values over time that indicate when similar and/or same products have sold for higher prices. For example, the e-commerce platform 102 observes that certain products tend to have higher resale values during specific times of the year, such as holiday seasons or product release anniversaries. In some embodiments, the e-commerce platform 102 uses time series analysis and/or regression models to predict future resale values based on historical data.

Once the selling time period is determined, the e-commerce platform 102 schedules the creation of a secondary resale listing for the new retail product by setting up a task that triggers at the identified selling time period. The pricing, in some embodiments, is set based on the predicted resale value for the selling time period to ensure that the listing is competitive and attractive to potential buyers. The e-commerce platform 102 uses the API connections established with the secondary marketplaces to automatically generate the resale listing.

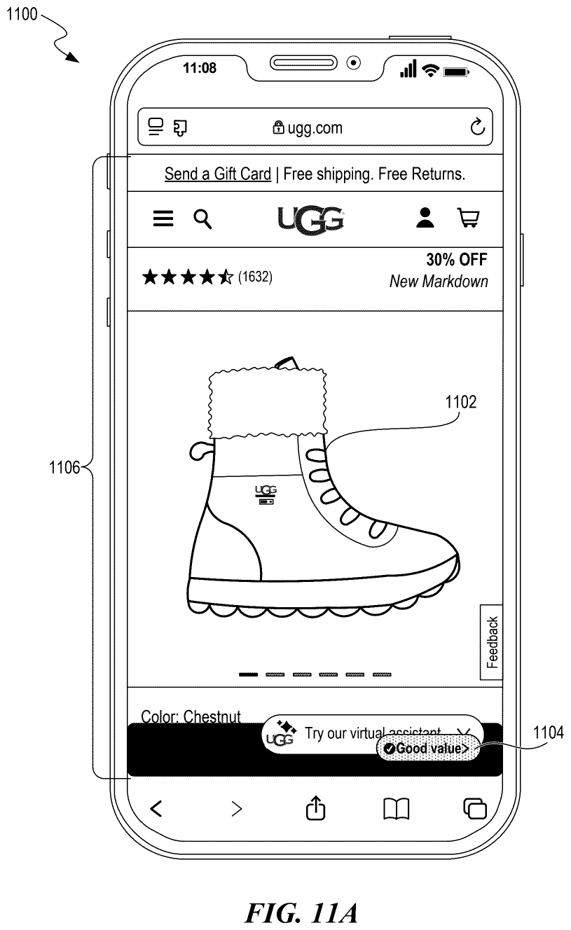

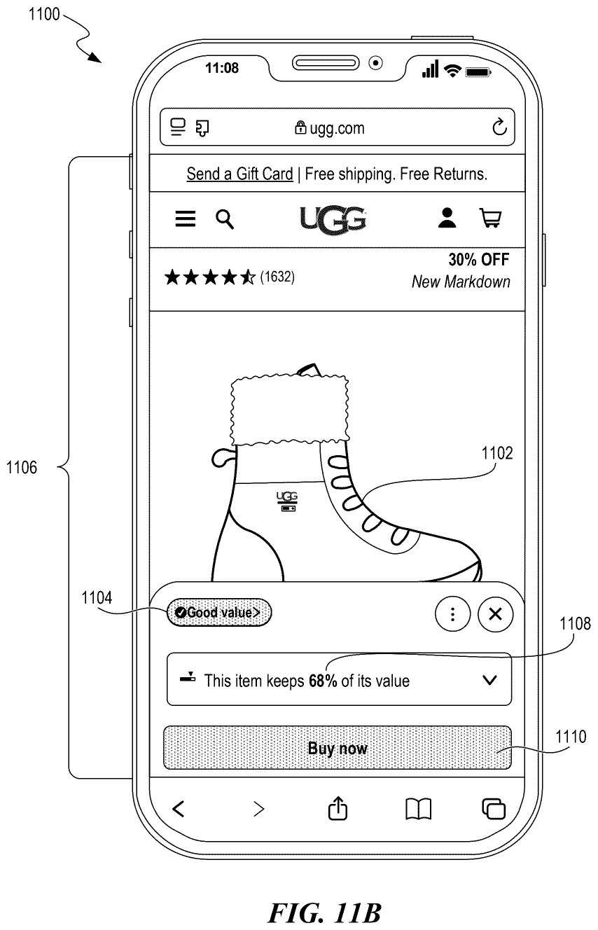

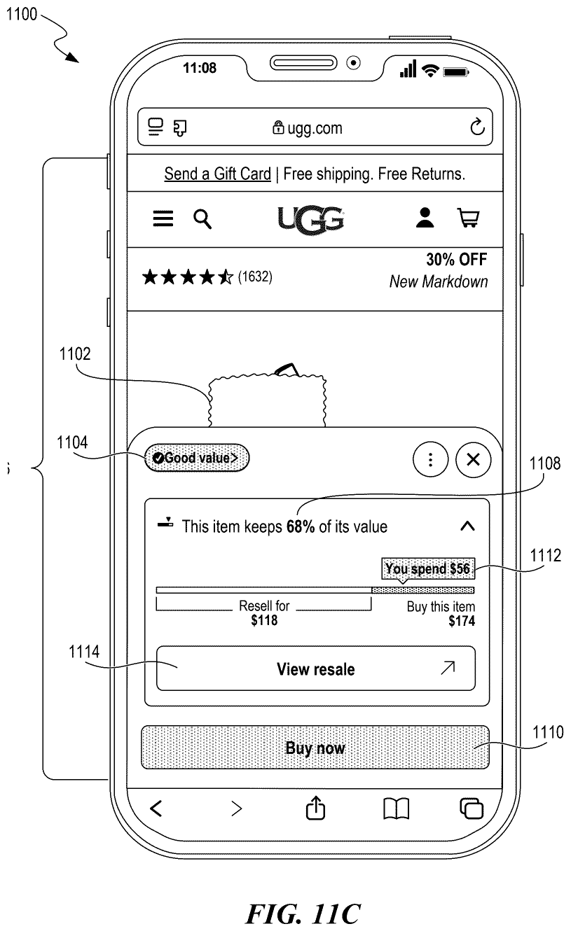

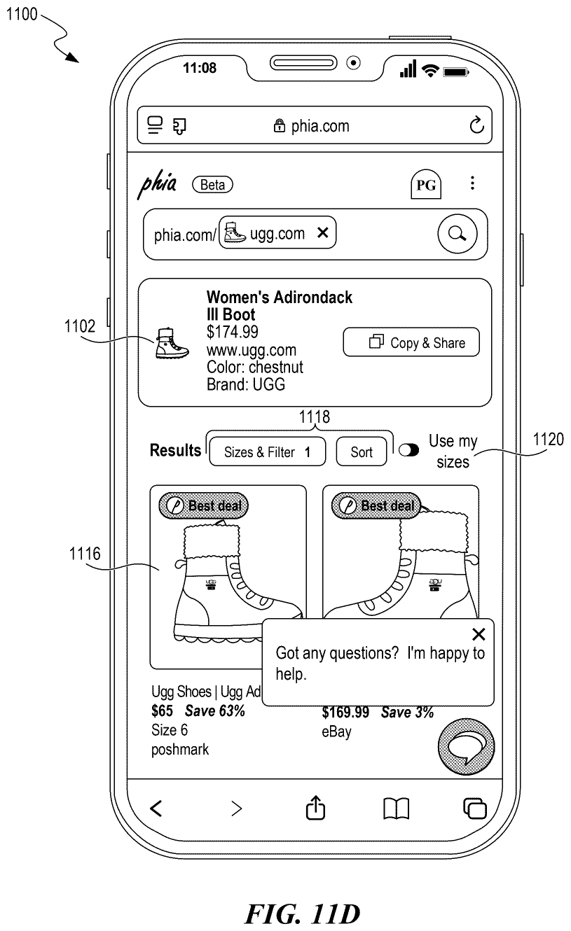

FIGS. 11A-11D illustrate a progressive sequence of browser extension states on a GUI 1100 that dynamically presents resale value information through integrated overlay elements on an e-commerce host web page. Embodiments of the GUI 1100 can include different and/or additional components or can be connected in different ways.

FIG. 11A is a screenshot of the GUI 1100 depicting a retail product 1102 and integrated with a floating interface element 1104 of the browser extension where the resale value is above a particular threshold. The browser extension presents graphical content in the form of a floating interface element 1104 on an existing web page 1106 (e.g., an e-commerce host web page) that appears as, for example, a “good deal,” “good value,” “bad deal,” or “bad value” indicator in a portion of the viewport. The floating interface element 1104 maintains the original page layout of the existing web page 1106 while signaling the availability of resale data to the user.

FIG. 11B is a screenshot of the GUI 1100 integrated with a graphic overlay of the browser extension. The graphic overlay includes a floating interface element 1104 positioned on the existing web page 1106, a predicted value of temporary ownership 1108, and a buy button 1110. The interface in FIG. 11B maintains visibility of the retail product 1102 while presenting an expanded floating element (i.e., a graphic overlay) including the predicted value of temporary ownership 1108, which, in FIG. 11B, states, “This item keeps 68% of its value.” The graphic overlay includes the buy button 1110, which is, for example, a “Buy Now” button that, once clicked on or otherwise interacted with by a user, triggers an original purchase workflow of the GUI 1100.

FIG. 11C is a screenshot of the GUI 1100 integrated with an expanded graphic overlay of the browser extension. The expanded graphic overlay includes the floating interface element 1104 positioned on the existing web page 1106, the predicted value of temporary ownership 1108, the buy button 1110, temporary ownership details 1112, and a resale button 1114. The e-commerce platform 102 parses the original retail price (e.g., $174), computes the projected resale value (e.g., $118), and displays the derived cost of temporary ownership (e.g., $56). The resale button 1114 (e.g., “View resale” button in FIG. 11C) enables navigation within the extension web page of the browser extension and/or navigation within a secondary market. For example, when the user clicks on this button, the user is taken to the extension user interface (e.g., the extension user interface of FIG. 11D) where the user is enabled to view active resale listings for the item. Users are thus enabled to shop for resale deals from the secondary market(s) directly from the extension user interface.

FIG. 11D is a screenshot of an extension user interface (e.g., an app screen interface) of the browser extension. The extension user interface includes the retail product 1102, secondary sale listings 1116, general filters 1118, and user-specific filters 1120. The general filters 1118 are used to refine search parameters across multiple dimensions including price, condition, marketplace source, and so forth. The user-specific filters 1120 enable personalized filtering through saved preferences such as size selections. The extension user interface displays standardized product information of the retail product 1102 including brand identification, product name, current retail price, and so forth.

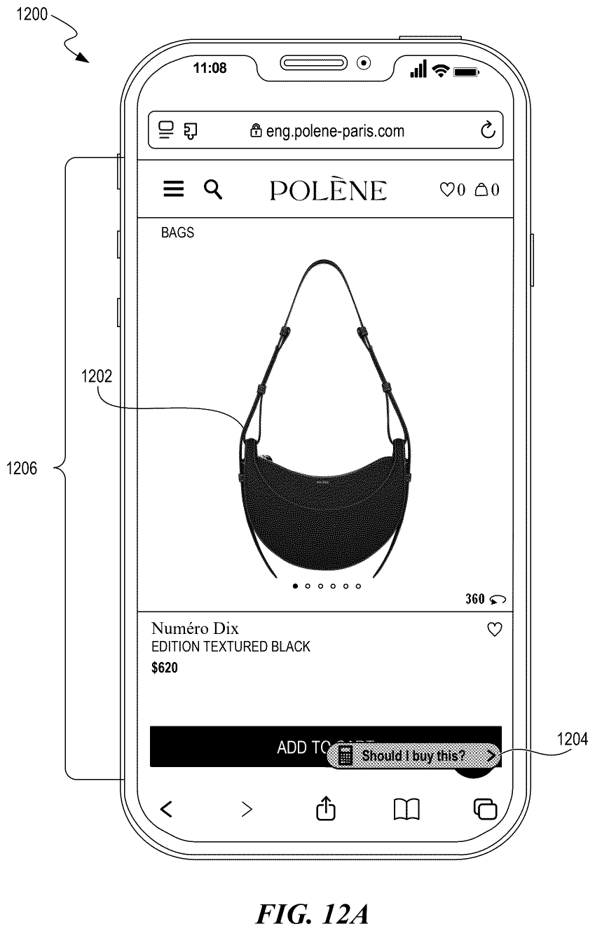

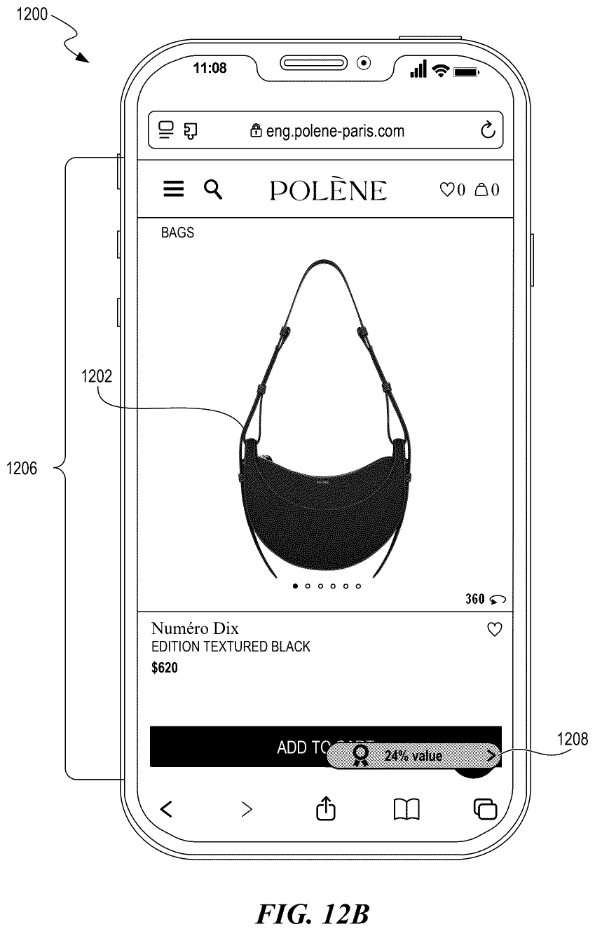

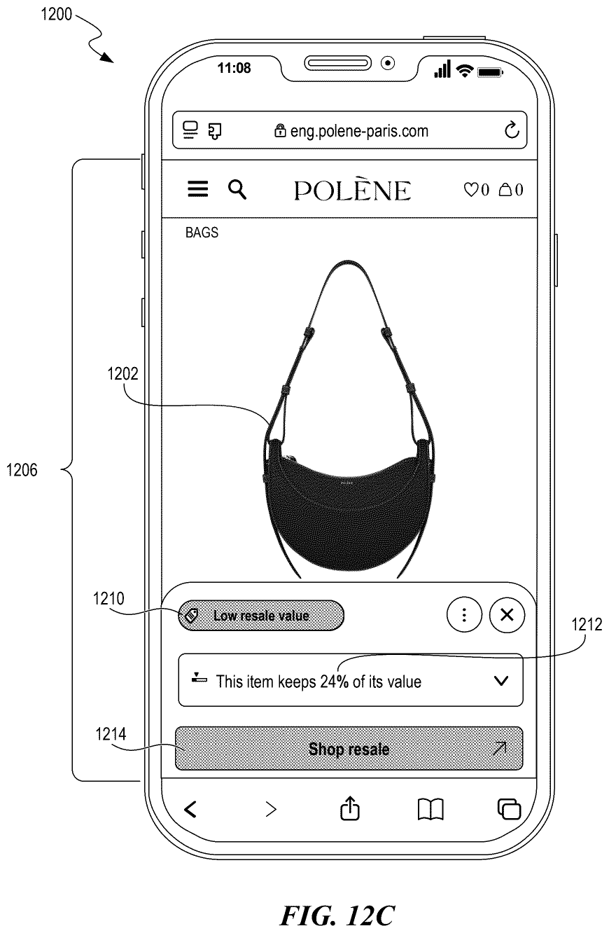

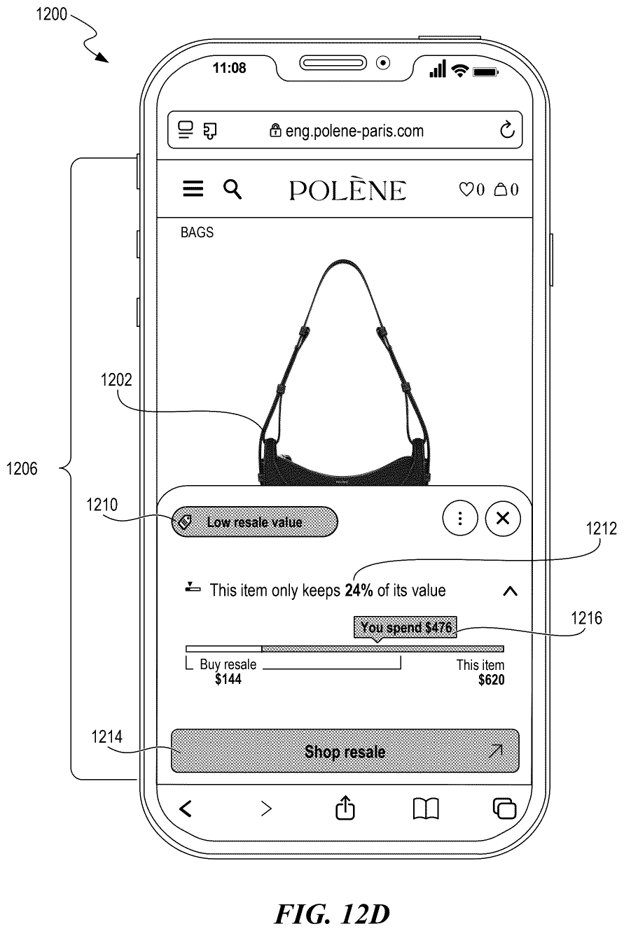

FIGS. 12A-12D are screenshots of a GUI 1200 depicting a retail product 1202 integrated with the browser extension where the resale value is below a particular threshold. In FIG. 12A, the GUI 1200 includes the floating interface element 1204 injected onto an existing web page 1206 (e.g., the existing web page 1106 in FIGS. 11A-11C), along with the original e-commerce elements including product image(s), pricing (e.g., $620), and product specifications. For example, the floating interface element 1204 appears as a “Should I buy this?” indicator in the lower portion of the viewport. The browser extension maintains the original page layout while signaling the availability of alternative purchasing options. In some embodiments, in response to receiving a user interaction (e.g., a swipe, a tap, a click), the GUI 1200 is enabled to display a modified floating interface element 1208 that provides information associated with an estimated value of temporary ownership (e.g., “24% value”).

In FIG. 12C, the GUI 1200 further includes an indication of the predicted value of temporary ownership (e.g., temporary ownership indicator 1210) and a resale button 1214. The predicted value of temporary ownership 1212 includes a visualization (e.g., a percentage-based visualization stating, “This item only keeps 24% of its value”) indicating a below-threshold retention rate. The browser extension includes an actionable resale button 1214 (e.g., “Shop resale” button) that redirects users to current secondary market listings. In FIG. 12D, the GUI 1200 further includes temporary ownership details 1216. The interface retains the temporary ownership indicator 1210 and predicted value of temporary ownership 1212 while introducing the temporary ownership details 1216. Similarly to FIG. 11C, the e-commerce platform 102 parses the original retail price ($620), computes the projected resale value ($144), and displays the potential savings ($476).

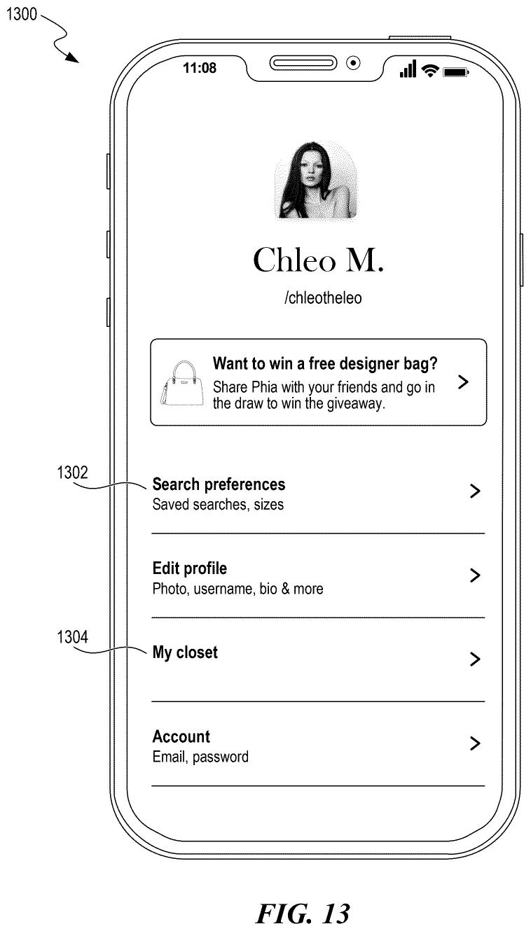

FIG. 13 is a screenshot of a user profile screen 1300 of the browser extension. The user profile screen 1300 includes search preferences 1302 and a digital inventory indicator 1304. Embodiments of the user profile screen 1300 can include different and/or additional components or can be connected in different ways. In some embodiments, the search preferences 1302 provide structured controls for configuring default search parameters, including saved search queries and/or size specifications that persist across browsing sessions. The digital inventory indicator 1304 enables integration with the user's virtual closet functionality. The user profile screen 1300 includes, in some embodiments, additional sections for profile customization, including photo uploads, username configuration, biographical information, and/or account security settings for email and password management.

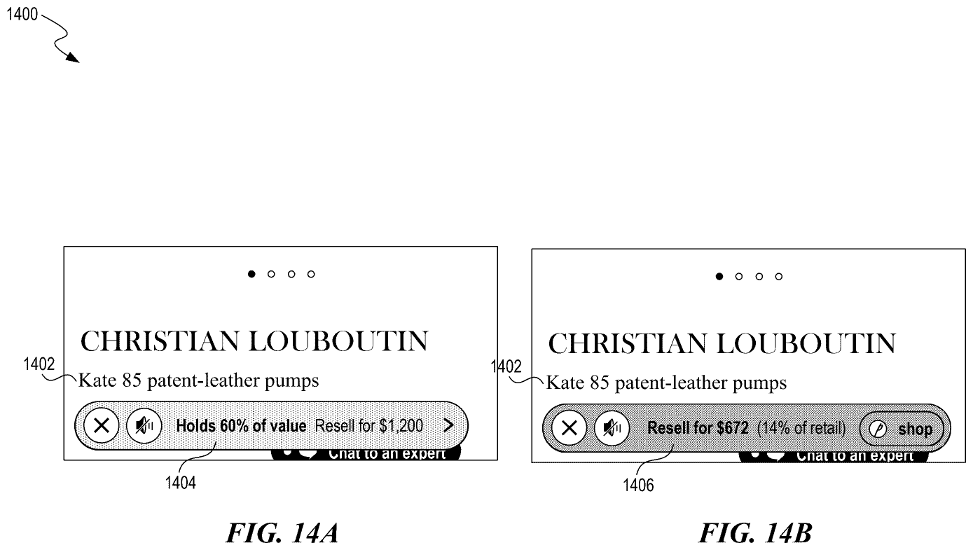

FIGS. 14A and 14B are two screenshots of the same host web page 1400 depicting the same retail product 1402, where the browser extension presents different graphic content 1404 and 1406. Embodiments of the host web page 1400 can include different and/or additional components or can be connected in different ways. The retail product 1402 maintains consistent positioning and presentation across both interface states while the browser extension injects contextually appropriate overlay content 1404. In FIG. 14A, the graphic content 1404 displays positive resale metrics, indicating “Holds 60% of value” with a projected resale value of $1,200, implementing an optimistic visual treatment. In FIG. 14B, the graphic content 1406 presents alternative messaging showing “Resell for $672 (14% of retail),” using a visually distinct treatment to emphasize the significant value depreciation.

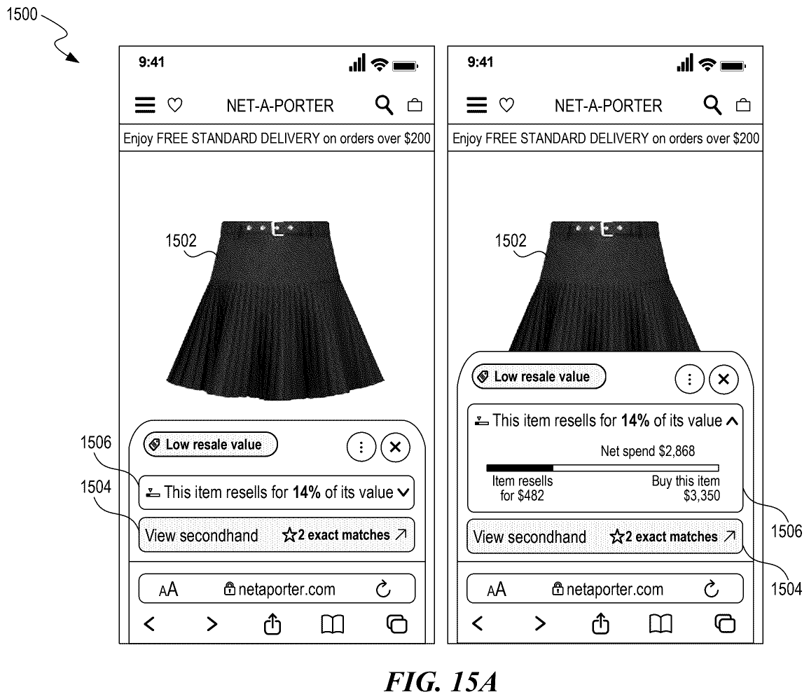

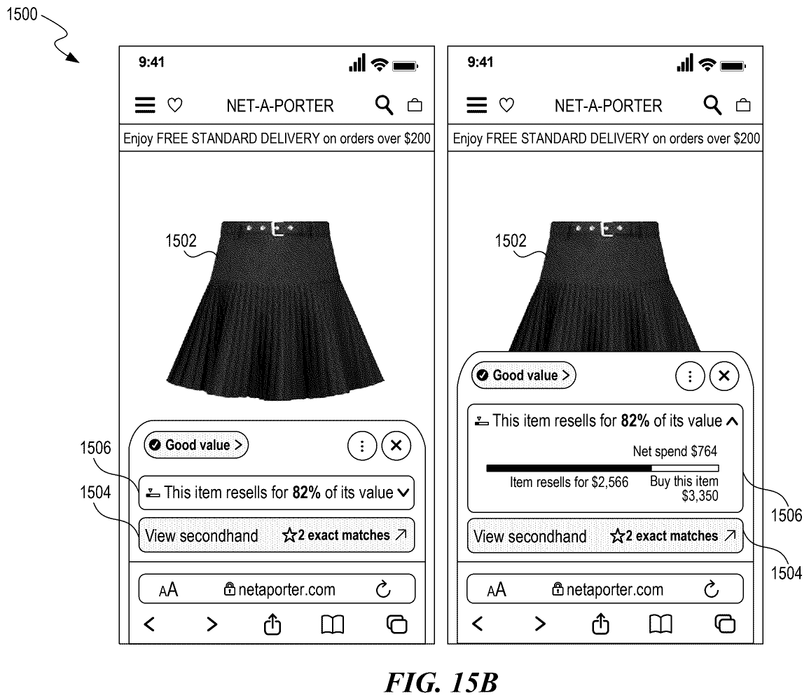

FIGS. 15A and 15B are screenshots of the same host web page 1500 depicting the same retail product 1502 (e.g., retail product 1402 in FIG. 14), where the browser extension presents different graphic content based on whether a product has a predicted resale value over a particular threshold. Embodiments of the host web page 1500 can include different and/or additional components or can be connected in different ways. As with FIG. 14, the retail product 1502 maintains consistent positioning and presentation across FIGS. 15A and 15B. The browser extension injects overlay content 1504 in FIG. 15A. The overlay content 1506 includes, for example, a predicted value of temporary ownership. Responsive to receiving a user interaction (e.g., a click, swipe, touch, and so forth) with the overlay content 1504, the browser extension expands into expanded overlay content 1506. The expanded overlay content 1506 includes, for example, the predicted resale value, the current cost of the retail product, a net spending value, and so forth. Different colors or other visual treatments, in some embodiments, are selected based on whether the predicted value of temporary ownership is above a certain threshold. For example, the predicted value of temporary ownership is below the threshold in FIG. 15A, but above the threshold in FIG. 15B.

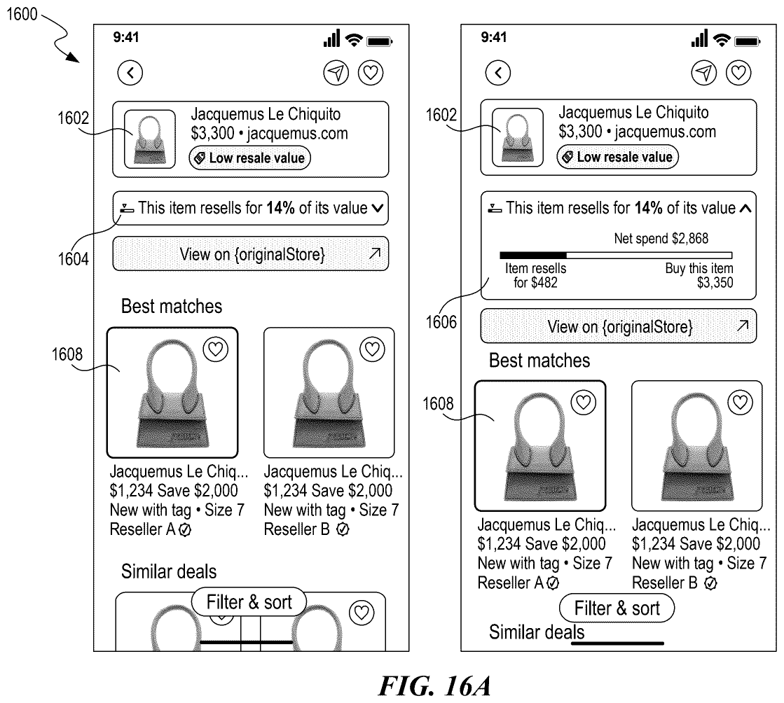

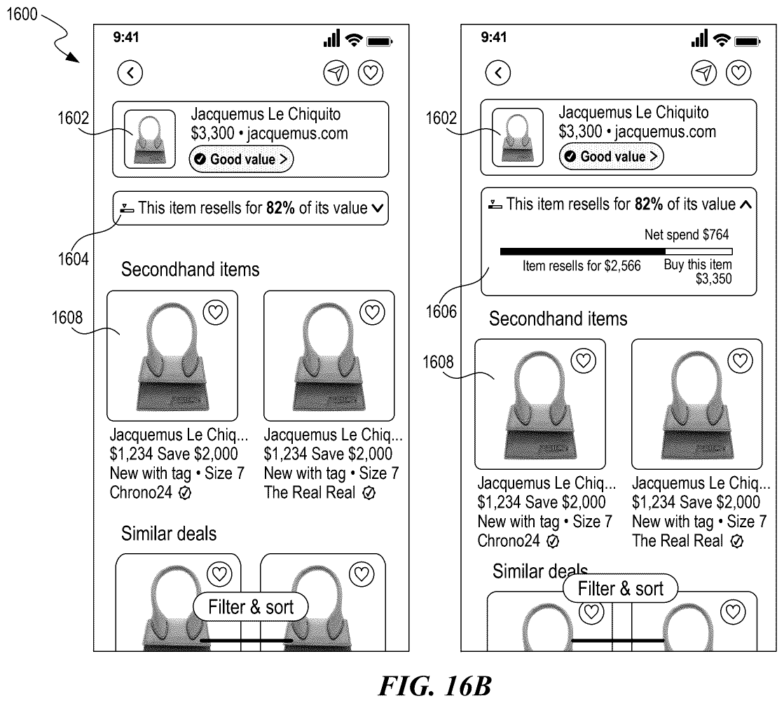

FIGS. 16A and 16B are screenshots of the same user interface 1600 depicting the same retail product 1602 (e.g., retail product 1402 in FIG. 14, retail product 1502 in FIG. 15), where the user interface presents different graphic content based on whether a product has a predicted resale value over a particular threshold. Embodiments of the user interface 1600 can include different and/or additional components or can be connected in different ways. The user interface 1600 includes, for example, the predicted value of temporary ownership 1604 (e.g., the predicted value of temporary ownership 1212 in FIG. 12D). Responsive to receiving a user interaction (e.g., a click, swipe, touch, and so forth) with the predicted value of temporary ownership 1604, the user interface expands into temporary ownership details 1606 (e.g., temporary ownership details 1216 in FIG. 12D). The user interface 1600 includes, in some embodiments, a set of secondary sale listings 1608 (e.g., secondary sale listings 1116 in FIG. 11D). As with FIGS. 14A-15B, different colors or other visual treatments, in some embodiments, are selected based on whether the predicted value of temporary ownership is above a certain threshold. For example, the predicted value of temporary ownership is below the threshold in FIG. 16A, but above the threshold in FIG. 16B.

### Computing Platform of the E-Commerce Platform

FIG. 17 is a block diagram illustrating an example computer system 1700, in accordance with one or more embodiments. In some embodiments, components of the example computer system 1700 are used to implement the software platforms described herein. At least some operations described herein can be implemented on the computer system 1700.

In some embodiments, the computer system 1700 includes one or more central processing units (“processors”) 1702, main memory 1706, non-volatile memory 1710, network adapters 1712 (e.g., network interface), video displays 1718, input/output devices 1720, control devices 1722 (e.g., keyboard and pointing devices), drive units 1724 including a storage medium 1726, and a signal generation device 1720 that are communicatively connected to a bus 1716. The bus 1716 is illustrated as an abstraction that represents one or more physical buses and/or point-to-point connections that are connected by appropriate bridges, adapters, or controllers. The bus 1716, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1794 bus (also referred to as “Firewire”).

In some embodiments, the computer system 1700 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1700.

While the main memory 1706, non-volatile memory 1710, and storage medium 1726 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1728. The term “machine-readable medium” and “storage medium” shall also be taken to include any medium that is capable of storing, encoding, or carrying a set of instructions for execution by the computer system 1700. In some embodiments, the non-volatile memory 1710 or the storage medium 1726 is a non-transitory, computer-readable storage medium storing computer instructions, which is executable by one or more “processors” 1702 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1704, 1708, 1728) set at various times in various memory and storage devices in a computer device. When read and executed by one or more processors 1702, the instruction(s) cause the computer system 1700 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1710, floppy and other removable disks, hard disk drives, optical discs (e.g., compact disc read-only memory (CD-ROMS), digital versatile discs (DVDs)), and transmission-type media such as digital and analog communication links.

The network adapter 1712 enables the computer system 1700 to mediate data in a network 1714 with an entity that is external to the computer system 1700 through any communication protocol supported by the computer system 1700 and the external entity. The network adapter 1712 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1712 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

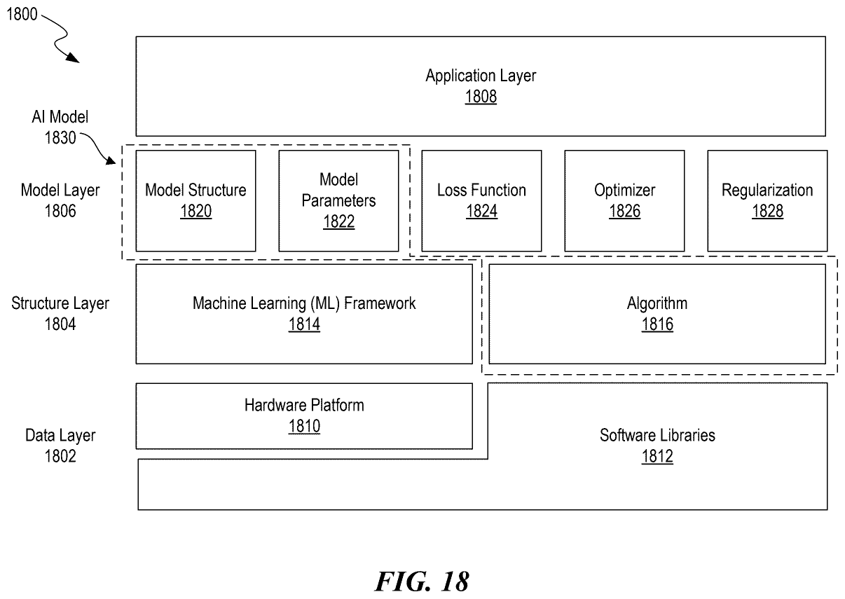

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1800 illustrated and described in more detail with reference to FIG. 18.

### AI System of the E-Commerce Platform

FIG. 18 is a high-level block diagram illustrating an example AI system, in accordance with one or more embodiments. The AI system 1800 is implemented using components of the example computer system 1800 illustrated and described in more detail with reference to FIG. 17. Likewise, embodiments of the AI system 1800 include different and/or additional components or be connected in different ways.

In some embodiments, as shown in FIG. 18, the AI system 1800 includes a set of layers, which conceptually organize elements within an example network topology for the AI system's architecture to implement a particular AI model 1830. Generally, an AI model 1830 is a computer-executable program implemented by the AI system 1800 that analyses data to make predictions. Information passes through each layer of the AI system 1800 to generate outputs for the AI model 1830. The layers include a data layer 1802, a structure layer 1804, a model layer 1806, and an application layer 1808. The algorithm 1816 of the structure layer 1804 and the model structure 1820 and model parameters 1822 of the model layer 1806 together form the example AI model 1830. The optimizer 1826, loss function engine 1824, and regularization engine 1828 work to refine and optimize the AI model 1830, and the data layer 1802 provides resources and support for the application of the AI model 1830 by the application layer 1808.

The data layer 1802 acts as the foundation of the AI system 1800 by preparing data for the AI model 1830. As shown, in some embodiments, the data layer 1802 includes two sub-layers: a hardware platform 1810 and one or more software libraries 1812. The hardware platform 1810 is designed to perform operations for the AI model 1830 and includes computing resources for storage, memory, logic, and networking, such as the resources described in relation to FIG. 1. The hardware platform 1810 processes amounts of data using one or more servers. The servers can perform backend operations such as matrix calculations, parallel calculations, machine learning (ML) training, and the like. Examples of servers used by the hardware platform 1810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1810 includes Infrastructure as a Service (IaaS) resources, which are computing resources, (e.g., servers, memory, etc.) offered by a cloud services provider. In some embodiments, the hardware platform 1810 includes computer memory for storing data about the AI model 1830, application of the AI model 1830, and training data for the AI model 1830. In some embodiments, the computer memory is a form of random-access memory (RAM), such as dynamic RAM, static RAM, and non-volatile RAM.

In some embodiments, the software libraries 1812 are thought of as suites of data and programming code, including executables, used to control the computing resources of the hardware platform 1810. In some embodiments, the programming code includes low-level primitives (e.g., fundamental language elements) that form the foundation of one or more low-level programming languages, such that servers of the hardware platform 1810 can use the low-level primitives to carry out specific operations. The low-level programming languages do not require much, if any, abstraction from a computing resource's instruction set architecture, allowing them to run quickly with a small memory footprint. Examples of software libraries 1812 that can be included in the AI system 1800 include Intel Math Kernel Library, Nvidia cuDNN, Eigen, and Open BLAS.

In some embodiments, the structure layer 1804 includes an ML framework 1814 and an algorithm 1816. The ML framework 1814 can be thought of as an interface, library, or tool that allows users to build and deploy the AI model 1880. In some embodiments, the ML framework 1814 includes an open-source library, an application programming interface (API), a gradient-boosting library, an ensemble method, and/or a deep learning toolkit that works with the layers of the AI system facilitate development of the AI model 1830. For example, the ML framework 1814 distributes processes for the application or training of the AI model 1830 across multiple resources in the hardware platform 1810. In some embodiments, the ML framework 1814 also includes a set of pre-built components that have the functionality to implement and train the AI model 1830 and allow users to use pre-built functions and classes to construct and train the AI model 1830. Thus, the ML framework 1814 can be used to facilitate data engineering, development, hyperparameter tuning, testing, and training for the AI model 1830. Examples of ML frameworks 1814 that can be used in the AI system 1800 include TensorFlow, PyTorch, Scikit-Learn, Keras, Caffe, LightGBM, Random Forest, and Amazon Web Services.

In some embodiments, the algorithm 1816 is an organized set of computer-executable operations used to generate output data from a set of input data and can be described using pseudocode. In some embodiments, the algorithm 1816 includes complex code that allows the computing resources to learn from new input data and create new/modified outputs based on what was learned. In some implementations, the algorithm 1816 builds the AI model 1830 through being trained while running computing resources of the hardware platform 1810. The training allows the algorithm 1816 to make predictions or decisions without being explicitly programmed to do so. Once trained, the algorithm 1816 runs at the computing resources as part of the AI model 1830 to make predictions or decisions, improve computing resource performance, or perform tasks. The algorithm 1816 is trained using supervised learning, unsupervised learning, semi-supervised learning, and/or reinforcement learning.

The application layer 1808 describes how the AI system 1800 is used to solve problems or perform tasks. In an example implementation, egress web gateway uses the application layer 1808 to intercept communication between the client device 104 and email server API 108.

As an example, to train an AI model 1830 that is intended to model human language (also referred to as a language model), the data layer 1802 is a collection of text documents, referred to as a text corpus (or simply referred to as a corpus). The corpus represents a language domain (e.g., a single language), a subject domain (e.g., email receipts), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1802 is annotated with ground truth labels (e.g., each data entry in the training dataset is paired with a label), or unlabeled.

Training an AI model 1830 generally involves inputting into an AI model 1830 (e.g., an untrained ML model) data layer 1802 to be processed by the AI model 1830, processing the data layer 1802 using the AI model 1830, collecting the output generated by the AI model 1830 (e.g., based on the inputted training data), and comparing the output to a desired set of target values. If the data layer 1802 is labeled, the desired target values, in some embodiments, are, e.g., the ground truth labels of the data layer 1802. If the data layer 1802 is unlabeled, the desired target value is, in some embodiments, a reconstructed (or otherwise processed) version of the corresponding AI model 1830 input (e.g., in the case of an autoencoder), or is a measure of some target observable effect on the environment (e.g., in the case of a reinforcement learning agent). The parameters of the AI model 1830 are updated based on a difference between the generated output value and the desired target value. For example, if the value outputted by the AI model 1830 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1830 typically is to minimize one or more loss function(s) or maximize a reward function.

In some embodiments, the data layer 1802 is a subset of a larger data set. For example, a data set is split into three mutually exclusive subsets: a training set, a validation (or cross-validation) set, and a testing set. The three subsets of data, in some embodiments, are used sequentially during AI model 1830 training. For example, the training set is first used to train one or more ML models, each AI model 1830, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1830. Backpropagation is used to adjust (also referred to as update) the value/weights of the parameters in the AI model 1830, with the goal of optimizing the objective function. For example, a defined loss function is calculated by forward propagation of an input to obtain an output of the AI model 1830 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1830 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1830 is sufficiently converged with the desired target value), after which the AI model 1830 is considered to be sufficiently trained. The values of the learned parameters are then fixed and the AI model 1830 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1830 typically involves further training the ML model on a number of data samples (which may be smaller in number/cardinality than those used to train the model initially) that closely target the specific task. For example, an AI model 1830 for generating natural language that has been trained generically on publicly available text corpora is, e.g., fine-tuned by further training using specific training samples. In some embodiments, the specific training samples are used to generate language in a certain style or a certain format. For example, the AI model 1830 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a Deep Neural Network, or DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL Mistral-type, Llama-type and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

Prompt engineering is a process of structuring text that is able to be interpreted by a generative AI model. Predefined prompts, in some embodiments, serve as predefined templates or structured queries that already adhere to the expected format and content guidelines of specific AI models within the AI technologies. For example, in some embodiments, a prompt (e.g., command set) includes the following elements: instruction, context, input data, and an output specification.

Although a prompt is a natural language entity, a number of prompt engineering strategies help structure the prompt in a way that improves the quality of output. For example, in the prompt “Please generate an image of a bear on a bicycle for a children's book illustration,” “generate,” is the instruction, “for a children's book illustration” is the context, “bears on a bicycle” is the input data, and “an image” is the output specification. The techniques include being precise, specifying context, specifying output parameters, specifying target knowledge domain, and so forth.

Automatic prompt engineering techniques have the ability to, for example, include using a trained large language model (LLM) to generate a plurality of candidate prompts, automatically score the candidates, and select the top candidates.

In some embodiments, prompt engineering includes the automation of a target process—for instance, a prompt causes an AI model to generate computer code, call functions in an API, and so forth. Additionally, in some embodiments, prompt engineering includes automation of the prompt engineering process itself—for example, an automatically generated sequence of cascading prompts, in some embodiments, include sequences of prompts that use tokens from AI model outputs as further instructions, context, inputs, or output specifications for downstream AI models. In some embodiments, prompt engineering includes training techniques for LLMs that generate prompts (e.g., chain-of-thought prompting) and improve cost control (e.g., dynamically setting stop sequences to manage the number of automatically generated candidate prompts, dynamically tuning parameters of prompt generation models or downstream models).

Using predefined prompts generated from prompt engineering streamlines the user experience by aligning user inputs with the nuances of AI APIs and eliminating the need for users of application to manually ensure format compatibility or align the user input to the predetermined criteria. Users of the application leverage the predefined prompts to articulate their queries. In some embodiments, a template service specifies parameters that the user fills out on their own. An important goal of prompt engineering is to reduce hallucinations from the LLM (because misrepresenting user's items can be dangerous).

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A method of generating a predictive overlay interface within a host retail webpage, the method comprising:
generating, on an interface of a host web page, a floating interface element, wherein the interface displays a retail product;
obtaining product information from the host web page, wherein the product information includes one or more of: a product title, a product price, or a product description;
executing a code snippet integrated into a host source code of the host web page, wherein the code snippet is configured to execute an external call to an application programming interface (API) via Internet that determines an estimated resale value for the retail product based on (1) the product information and (2) historical resale data from multiple secondary marketplaces;
in response to executing the code snippet, populating the floating interface element with an indication of a projected cost of temporary ownership of the retail product determined as a difference between an original retail price and the estimated resale value of the retail product; and
in response to receiving an indication that the floating interface element has been selected by a user of the host web page, generating an overlay window on the interface of the host web page, the overlay window displaying information including (1) the estimated resale value and (2) the projected cost of temporary ownership, wherein the information displayed in the overlay window is not included in the host source code.

2. The method of claim 1, wherein determining the estimated resale value for the retail product further comprises:
calculating an average resale value of the retail product based on the historical resale data associated with the retail product,
calculating an average resale retention percentage based on the historical resale data associated with multiple different retail products, and
determining the estimated resale value for the retail product by applying the average resale retention percentage to the original retail price of the retail product.

3. The method of claim 1, further comprising:
adjusting the estimated resale value based on one or more of: item condition of the retail product, market demand of the retail product, or a degree of popularity within one or more consumer groups of the retail product.

4. The method of claim 1, further comprising:
upon receiving an indication of a purchase of the retail product by the user, automatically adding the retail product to a digital inventory associated with the user; and
tracking the estimated resale value of the retail product over time, wherein the estimated resale value is indicated within the digital inventory.

5. The method of claim 1, wherein the overlay window further includes one or more buttons, the method further comprising:
redirecting to a second web page in response to received input that the one or more buttons is clicked, wherein the second web page is associated with a set of secondary market listings of the retail product from a set of secondary online retailers.

6. The method of claim 1, wherein the indication that the floating interface element has been selected by the user of the host web page includes one or more of: (1) a user gesture on a touchscreen element of the interface in a position proximate to the floating interface element or (2) a received input that a user cursor associated with a user device is hovering over the floating interface element.

7. The method of claim 1, wherein the API determines the estimated resale value for the retail product based on (1) historical resale data of the retail product and (2) historical resale data of predicted products associated with the retail product, wherein the predicted products are determined using an artificial intelligence (AI) model.

8. A method of generating a predictive overlay interface integrated with a digital inventory, the method comprising:
maintaining a digital inventory of a user indicating purchased retail products and associated estimated resale values of the purchased retail products, the estimated resale values determined based on historical resale data from multiple secondary marketplaces;
obtaining product information from a host web page displaying a new retail product on an interface, wherein the new retail product is different from the purchased retail products;
executing a code snippet integrated into a host source code of the host web page, wherein the code snippet is configured to execute an external call to an application programming interface (API) via Internet that determines a corresponding estimated resale value for the new retail product based on (1) the product information and (2) the historical resale data from the multiple secondary marketplaces;
in response to executing the code snippet, generate, on the interface of the host web page, an overlay window displaying the corresponding estimated resale value of the new retail product; and
in response to receiving an indication that the new retail product has been purchased by the user, adding an indicator of the new retail product and the corresponding estimated resale value to the digital inventory.

9. The method of claim 8, wherein the API is further configured to:
determine a total portfolio value of the digital inventory including (1) the corresponding estimated resale value of the new retail product and (2) the associated estimated resale values of the purchased retail products;
determining an impact value on the total portfolio value if the new retail product is added to the digital inventory; and
presenting (1) the total portfolio value and (2) the impact value on the overlay window.

10. The method of claim 8, further comprising:
calculating a total portfolio value of the digital inventory including the estimated resale value of the new retail product; and
displaying the total portfolio value and aggregate earnings from previous sales within the overlay window.

11. The method of claim 8, further comprising:
updating the associated estimated resale values of the purchased retail products responsive to obtaining new market data; and
generating one or more notifications responsive to a change in one or more estimated resale values exceeding a predefined threshold.

12. The method of claim 8, further comprising:
filtering product listings from the multiple secondary marketplaces based on a set of keywords and a set of time periods; and
prioritizing the filtered product listings based on a confidence score associated with the filtering.

13. The method of claim 8, further comprising:
establishing a set of API connections with the multiple secondary marketplaces; and
determining the corresponding estimated resale value of the new retail product in association with each secondary marketplace of the multiple secondary marketplaces in parallel.

14. The method of claim 8, further comprising:
determining a selling time period of the new retail product based on one or more patterns associated with historical resale values of the new retail product; and
automatically generating a secondary resale listing for the new retail product at the selling time period.

15. A system comprising:
a host user device;
a database including historical resale data of multiple retail products from multiple secondary marketplaces;
a floating interface application configured to:
execute a code snippet integrated into a host source code of a host web page displaying a retail product on an interface, wherein the code snippet is configured to execute an external call to an application programming interface (API) via Internet that modifies the host web page, and
in response to executing the code snippet, generating, on the interface of the host web page, a floating interface element indicating product information of the retail product;
an API server configured to determine the product information by:
receiving the external call to the API,
determining an estimated resale value for the retail product based on (1) product information and (2) the historical resale data, wherein the product information includes one or more of: a product title, a product price, or a product description, and
determining a projected cost of temporary ownership determined as a difference between an original retail price and the estimated resale value;
a predictive overlay application configured to receive indication that the floating interface element has been activated by a user of the host web page and generate an overlay window to display the determined product information; and
a communication line that connects the host user device, an end-user device, the database, the floating interface application, the API server, and the predictive overlay application.

16. The system of claim 15, wherein the API server is further configured to:
obtain a set of resale prices of matching retail items across the multiple secondary marketplaces within the historical resale data,
determine an average resale value of the retail product based on the obtained resale prices, and
determine a brand-specific average resale retention percentage based on the historical resale data of multiple items sharing a common brand of the retail product.

17. The system of claim 15, wherein the API server is further configured to:
dynamically update the estimated resale value in response to obtaining new resale data absent from the historical resale data.

18. The system of claim 15, further comprising a digital inventory application configured to:
automatically add the retail product to a digital inventory of the user upon purchase of the retail product, and
automatically generate a set of secondary market listings of the retail product.

19. The system of claim 18, wherein the digital inventory application is further configured to:
calculate a total estimated value of all retail products in the digital inventory of the user,
track an aggregate earning determined based on completed secondary sales of one or more retail products in the digital inventory, and
display updates in accordance with a scheduled time period including one or more fluctuations of estimated resale values of one or more retail products in the digital inventory.

20. The system of claim 15,
wherein the host web page is associated with an electronic commerce store,
wherein the floating interface application is located proximate to a buy button region of the interface of the host web page, and
wherein the electronic commerce store includes a checkout screen that allows a purchase of the retail product in response to receiving user input within the buy button region.
